(19) United States
(12) Patent Application Publication
(10) Pub. No.: US 2026/0255306 A1
(43) Pub. Date: Aug. 27, 2026

(54) MEASUREMENT GENERATION AND REPORTING CONFIGURATION FOR UTILIZING ACTUAL OR PREDICTED COOPERATIVE MEASUREMENT TECHNIQUE(S)

(71) Applicant: QUALCOMM Incorporated, San Diego, CA (US)

(72) Inventors: Doohyun SUNG, Basking Ridge, NJ (US); Navid ABEDINI, Basking Ridge, NJ (US); Junyi LI, Greentown, PA (US)

(21) Appl. No.: 19/066,123

(22) Filed: Feb. 27, 2025

(51) Int. Cl. H04W 64/00; H04W 24/10; H04W 36/00

(52) U.S. Cl. CPC H04W 64/00; H04W 24/10; H04W 36/0058

(57) ABSTRACT

Certain aspects of the present disclosure provide techniques for measurement generation and reporting. An example method for wireless communications by a user equipment (UE) may include: identifying a group of UEs to which the UE belongs, the group of UEs associated with a co-location condition; obtaining a cooperative measurement output based on, at least, an actual or predicted cooperative measurement by a subset of the group of UEs; and reporting at least one measurement value, wherein the at least one measurement value is based on the cooperative measurement output.

### INTRODUCTION

### Field of the Disclosure

Aspects of the present disclosure relate to wireless communications, and more particularly, to techniques for measurement generation and reporting.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes identifying a group of UEs to which the UE belongs, the group of UEs associated with a co-location condition; obtaining a cooperative measurement output based on, at least, an actual or predicted cooperative measurement by a subset of the group of UEs; and reporting at least one measurement value, wherein the at least one measurement value is based on the cooperative measurement output.

Certain aspects provide a method for wireless communications by a network entity. The method includes sending, to a UE, signaling that configures the UE to report at least one measurement value, wherein: the at least one measurement value is based on a cooperative measurement output, the cooperative measurement output is based on, at least, an actual or predicted cooperative measurement by a subset of a group of UEs to which the UE belongs, and the group of UEs are associated with a co-location condition; and obtaining, from the UE, the at least one measurement value based on the signaling.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 illustrates an example artificial intelligence (AI) architecture that may be used for AI-enhanced wireless communications.

FIG. 6 illustrates an example AI architecture of a first wireless device that is in communication with a second wireless device.

FIG. 7 illustrates an example artificial neural network.

FIG. 8 depicts an example of UE mobility in a wireless communications network.

FIG. 9 depicts example UE cooperative operation, such as for measurement generation and reporting.

FIG. 10 depicts a process flow for communications in a network between a network entity and multiple UEs, including a first UE, such as to configure the first UE to utilize cooperative measurement technique(s) for measurement generation and reporting.

FIG. 11 depicts example filter coefficients that may be used for infinite impulse response (IIR) filtering, such as prior to measurement reporting.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for configuring a user equipment (UE) to utilize (1) a combination of two or more cooperative measurement techniques or (2) a combination of one or more cooperative measurement techniques and legacy measurement(s) at the UE, such as for measurement generation and reporting. As used herein, “cooperative measurement techniques” (also referred to as “actual or predicted cooperative measurements”) may refer to techniques where multiple UEs communicate and collaborate with one another to generate one or more measurements (referred to herein as “actual measurement(s)”) and/or one or more measurement predictions, and then report such measurement(s) and/or measurement predication(s) to a network entity.

Mobility, also commonly referred to as “handover,” is a process of transferring an ongoing communication session of a UE from a source cell associated with a source node (e.g., a source network entity) to a target cell associated with a target node (e.g., a target network entity), while the UE is in a connected mode (also referred to as a “connected state,” “radio resource control (RRC) connected mode,” and/or “RRC connected state”). A UE may be operating in a connected mode in a radio access network (RAN) after establishing an RRC connection with a network entity in the RAN and after radio resources are allocated to the UE. The target cell may belong to either a same network entity as the source cell (e.g., intra-network entity (e.g., intra-base station (BS)) handover) or a different network entity than the network entity associated with the source cell (e.g., inter-network entity (e.g., inter-BS) handover). One of the motivations behind handover procedures is to assist in the seamless connectivity and continuity of service for the UE, especially while the UE is mobile.

New Radio (NR) supports different types of handover, including handover procedures where the network controls the UE's mobility, such as based on UE measurement reporting. For example, for network-triggered layer 3 (L3)-based handover, a UE may perform one or more radio resource management (RRM) measurements for one or more signals (e.g., reference signal(s)) received at the UE. As used herein, “RRM” refers to techniques for managing radio frequency spectrum resources (simply “radio resources”) and radio network infrastructure within a wireless communications network. An “RRM measurement” may involve measuring the strength and/or quality of a signal (e.g., a reference signal) sent to the UE. To perform the one or more RRM measurements, the UE may determine a reference signal received power (RSRP), a reference signal strength indicator (RSSI), a reference signal received quality (RSRQ), a signal-to-noise ratio (SNR), and/or a signal-to-interference plus noise ratio (SINR), among others, for each signal received at the UE. The UE may report such measurement(s) to a source network entity (e.g., associated with a source cell), and the source network entity may use the reported measurement(s) to make decisions related to mobility of the UE. In some cases, based on the measurement(s), the source network entity may trigger a handover for the UE by transmitting a handover request to a target network entity associated with a target cell. For example, due to better channel conditions for a communications channel between the UE and the target network entity than a communications channel between the UE and the source network entity (e.g., determined based on the measurement(s)), the source network entity may decide to switch the UE's connection from the source cell to the target cell.

One solution that may aid in improving UE mobility performance, such as for network-triggered L3-based handover, includes the use of artificial intelligence (AI). More specifically, one or more machine learning (ML) models may be deployed at or on the UE to support the generation of one or more predictions, such as measurement prediction(s), that may be used to help optimize (or improve) handover procedures for the UE. For example, ML is an efficient tool that may be used to help reduce the complexity involved in (1) cell discovery (e.g., selecting a cell for a handover of the UE, such as based on some criteria), (2) handover initiation determination (e.g., determining when the handover of the UE should take place), and/or (3) handover execution for achieving a quality of service (QoS) with a suitable value (e.g., satisfies a threshold, achieves maximum QoS, etc.).

As an illustrative example, in some cases, the UE may use the one or more ML models to predict future signal strength measurements for future signals communicated via a communications channel between the UE and a source network entity. The predicted signal strength measurements may be reported to the source network entity, such as to enable the source network entity to proactively anticipate the channel conditions for the communications channel between the UE and the source network entity. In some cases, the source network entity may use this knowledge to trigger a handover of the UE, such as before a radio link failure and/or unsatisfactory channel conditions (e.g., does not satisfy a threshold, etc.) result for the communications channel. Although in this example, the UE may use the one or more ML models for future signal strength measurement predictions, in some other examples, the ML model(s) may be used to generate other measurement prediction(s). For example, an ML model may be used to predict the performance of one set of beams at a given time, given performance of another set of beams at the given time. As another example, an ML model may be used to predict a time at which a handover will be triggered. As another example, an ML model may be used to predict a beam that will be used for a target cell in a handover.

Actual and/or predicted measurements used for handover procedures may generally be performed on a “per-UE” basis, meaning that each individual UE connected to a source network entity may be (1) configured to generate and report its own measurement(s) (e.g., actual and/or predicted) to a network entity, (2) perform actual measurement(s) and/or generate measurement prediction(s)), and (3) report the output of these measurement(s) and/or prediction(s) to the source network entity. For example, the handover of a UE, connected to the source network entity, may generally be based on the specific channel conditions and/or signal quality experienced by the UE, and reported to the source network entity, while the UE is in a particular geographic location. The measurement(s) and/or prediction(s) reported by each UE may enable the source network entity to evaluate the mobility potential for each UE.

Technical problems associated with “per UE” measurement and reporting, such as for network-triggered handover procedures, may include, for example, redundant measurement operations among UEs and associated use of network resources that may be realized as a result of such redundancy. For example, in cases where UEs are co-located within an area (e.g., a co-location condition is satisfied for the UEs based on a respective geographic location of each of the UEs), and thus experiencing similar channel conditions (e.g., experiencing similar interference, similar signal strength, similar latency in communication, etc.), each UE reporting its measurement(s) to a source network entity (e.g., such as continuously or at fixed intervals) may contribute to a large amount of redundant information to be processed by the source network entity. For example, the source network entity may receive multiple measurement reports from the UEs with nearly identical or similar information, which may have little to no effect on the decision-making of the source network entity, such as for network-triggered handover decisions. Further, processing the identical or similar information associated with each UE may result in the source network entity unnecessarily analyzing duplicated information multiple times, thereby leading to redundant use of network resources, which may be better utilized elsewhere (e.g., such as for communications with other UEs). In networks with high user density, the source network entity may become overloaded (e.g., the demand for its resources may exceeds its available capacity) with measurement reports from the UEs, thereby adversely affecting network performance and/or user experience (e.g., may result in network congestion, QoS degradation, increased latency in communication, etc.). Further, inefficient resource usage may stem from redundant measurement reporting by the UEs, thereby causing network congestion, reduced throughput, and/or transmission latency.

Technical problems associated with “per UE” measurement and reporting may also include unnecessary resource usage and power consumption at the UEs. For example, a first UE measuring and reporting, to a source network entity, the same metrics as a second UE may not aid the source network entity in its decision-making (e.g., such as for network-triggered handover decisions), but may consume valuable network resources that could have been otherwise used by other UEs for data transmission. Further, measurement and transmission of such metrics may drain battery power for the first UE. In certain aspects, where the measurement(s) performed by the first UE include the generation of one or more measurement predictions via one or more ML models, the ML models may consume a large amount of memory, storage, and/or battery power, with minimal or no benefit associated with the output that is produced and reported to the network entity (e.g., where the second UE performs same or similar measurement prediction(s)).

One solution to overcoming the aforementioned technical problems may leverage cooperative operations among UEs. Traditional UE cooperative operations may refer to methods where multiple UEs communicate and collaborate with one another, such as to improve capacity and/or coverage in wireless communication networks. Example traditional UE cooperative operations may include UE relaying, interference coordination (e.g., where UEs adjust their transmission power to avoid certain frequency bands and thus minimize interference), and/or load balancing, to name a few. As used herein, UE cooperative operations may be utilized to enable communication and collaboration among UEs with respect to measurement generation and reporting. For example, instead of each UE individually generating measurement(s) and reporting its measurement(s) to a network entity, UEs that are co-located within a same area may collaborate to delegate and/or divide measurement, measurement prediction, and/or measurement reporting tasks, such as to reduce (or avoid) redundant operations at the UEs and the reporting of redundant information to the network, thereby improving overall efficiency.

The UE cooperative operations described herein, which are related to measurement generation and reporting, may be referred as “actual or predicted cooperative measurements,” or simply “cooperative measurement techniques.” Multiple cooperative measurement techniques may be considered to achieve the aforementioned efficiency gain. For example, a first cooperative measurement technique may include one or more delegate UEs performing actual measurement(s) on behalf of a first UE, and the first UE sending, to a source network entity, at least one measurement value based on the actual measurement(s) by the delegate UE(s) (e.g., “measurement delegation”). A second cooperative measurement technique may include one or more collaborative UEs and a first UE performing actual measurement(s) (e.g., such as each UE performing partial temporal and/or spatial measurements), and the first UE sending, to a source network entity, at least one measurement value based on the actual measurement(s) by the collaborative UE(s) and the first UE (e.g., “measurement collaboration”). A third cooperative measurement technique may include a first UE generating a measurement prediction based on the output from measurement delegation, and the first UE sending, to a source network entity, at least one measurement value based on the measurement prediction (e.g., “measurement prediction based on measurement delegation”). A fourth cooperative measurement technique may include a first UE generating a measurement prediction based on the output from measurement collaboration, and the first UE sending, to a source network entity, at least one measurement value based on the measurement prediction (e.g., “measurement prediction based on measurement collaboration”). A fifth cooperative measurement technique may include one or more delegate UEs generating measurement predictions(s) for a first UE, and the first UE sending, to a source network entity, at least one measurement value based on the measurement prediction(s) by the delegate UE(s) (e.g., “measurement prediction delegation”). A sixth cooperative measurement technique may include one or more collaborative UEs and a first UE generating measurement prediction(s), and the first UE sending, to a source network entity, at least one measurement value based on the measurement prediction(s) by the collaborative UE(s) and the first UE (e.g., “measurement prediction collaboration”).

Certain aspects described herein provide techniques for utilizing (1) a combination of two or more of the aforementioned cooperative measurement techniques or (2) a combination of one or more of the aforementioned cooperative measurement techniques and legacy measurement(s) at a UE, such as for measurement generation and reporting. For example, certain aspects described herein may provide configuration of a UE to utilize such combinations for measurement generation and reporting. In certain aspects, the configuration of the UE may specify the cooperative measurement technique(s) that may be used for measurement generation and reporting. In certain aspects, the configuration of the UE may specify whether one or more measurement value(s) are to be reported to the UE, and how these measurement value(s) may be determined based on the performance of the cooperative measurement technique(s) and/or the legacy measurement(s). In certain aspects, the configuration of the UE may specify event condition(s) that may need to be satisfied prior to reporting measurement value(s) to the network entity, where the measurement value(s) are determined based on the performance of cooperative measurement technique(s) and/or legacy measurement(s). In certain aspects, the configuration of the UE may specify sample filtering techniques that may be used for filtering measurement output from the performance of cooperative measurement technique(s) and/or a legacy measurement, such as prior to the generation of a measurement report, which may be sent to a source network entity. In certain aspects, the configuration of the UE may specify filtering techniques that may be used by the UE for smoothing measurement output (e.g., reduce noise and/or fluctuations in the measurement output) from the performance of cooperative measurement technique(s) and/or a legacy measurement. In certain aspects, the UE may be configured to use such filtering techniques prior to the generation of a measurement report, which may be sent to a source network entity. In certain aspects, the filtering techniques used for smoothing measurement output may involve the application of a digital filter to the measurement output. For example, the UE may use a finite impulse response (FIR) filter for FIR filtering or an infinite impulse response (IIR) filter for IIR filtering. In certain aspects, both “FIR filtering” and “IIR filtering” may be referred to as “time-domain filtering.” Further, in certain aspects, “IIR filtering” may be referred to as “layer 3 (L3) filtering.”

Certain techniques for configuring a UE for measurement generation and reporting, as described herein, may provide various beneficial technical effects and/or advantages. For example, the techniques for configuring a UE for measurement generation and reporting may enable a UE to utilize (1) a combination of two or more cooperative measurement techniques or (2) a combination of one or more cooperative measurement techniques and legacy measurement at a UE for measurement generation and reporting. The combined use of such techniques, including at least one cooperative measurement technique, for measurement generation and reporting may help to achieve improved wireless communications performance, such as improved network efficiency (e.g., better resource utilization) and reduced power consumption at a network entity and/or one or more UEs. The improved network efficiency and reduced power consumption may be attributable to (1) the reduction in redundant operations among UEs for measurement generation and reporting and (2) thus, the reduction in redundant information to be processed by a network entity (e.g., such as for handover decisions), which are both capable of being achieved when using at least one cooperative measurement technique for measurement generation and reporting.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

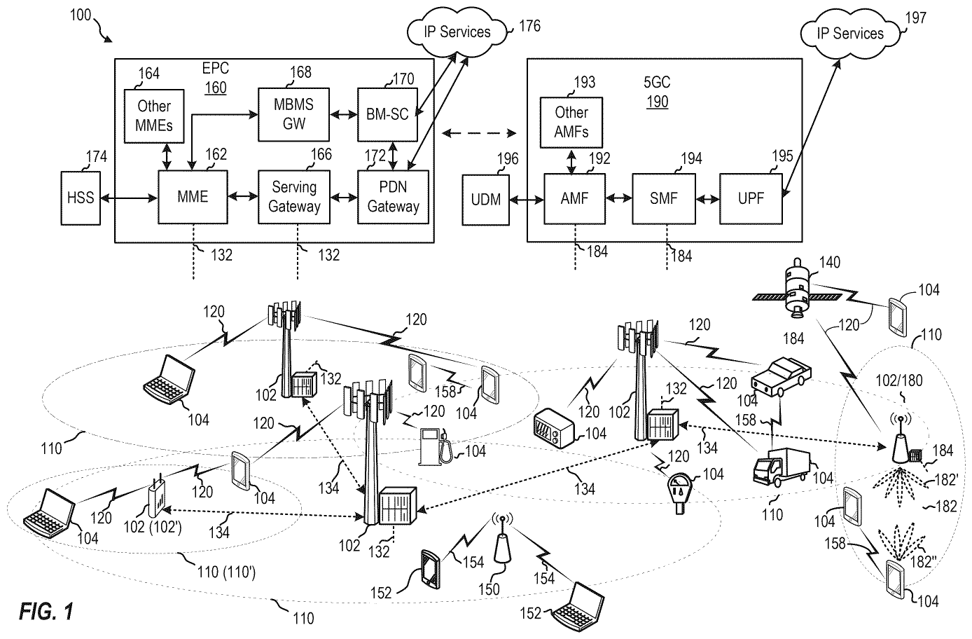

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

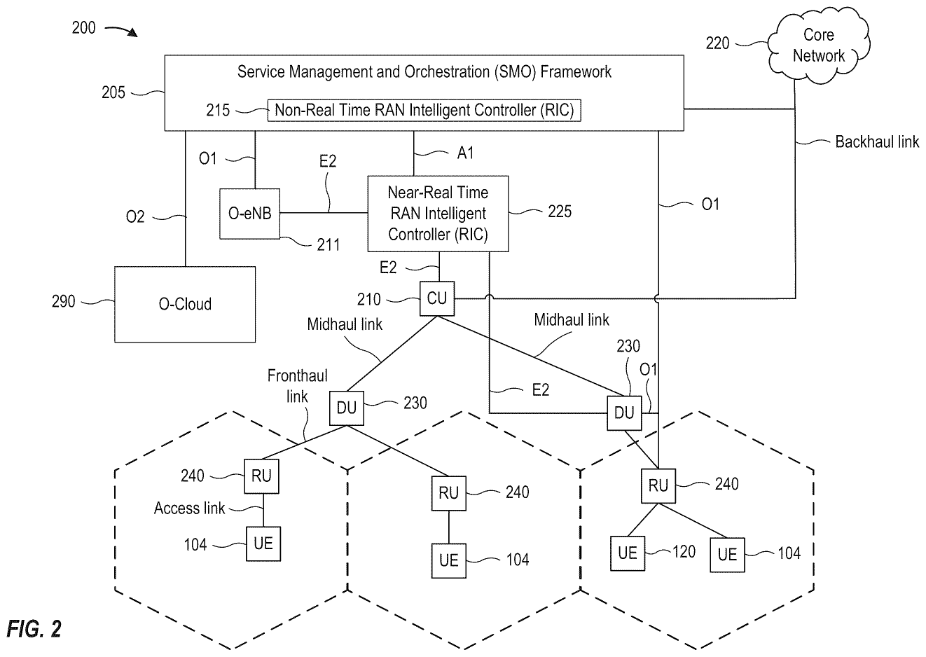

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

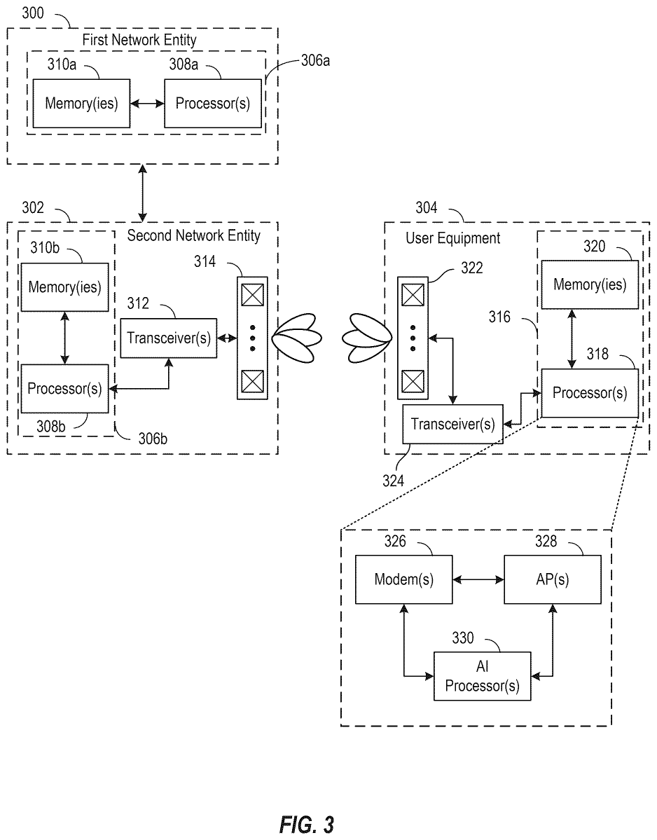

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

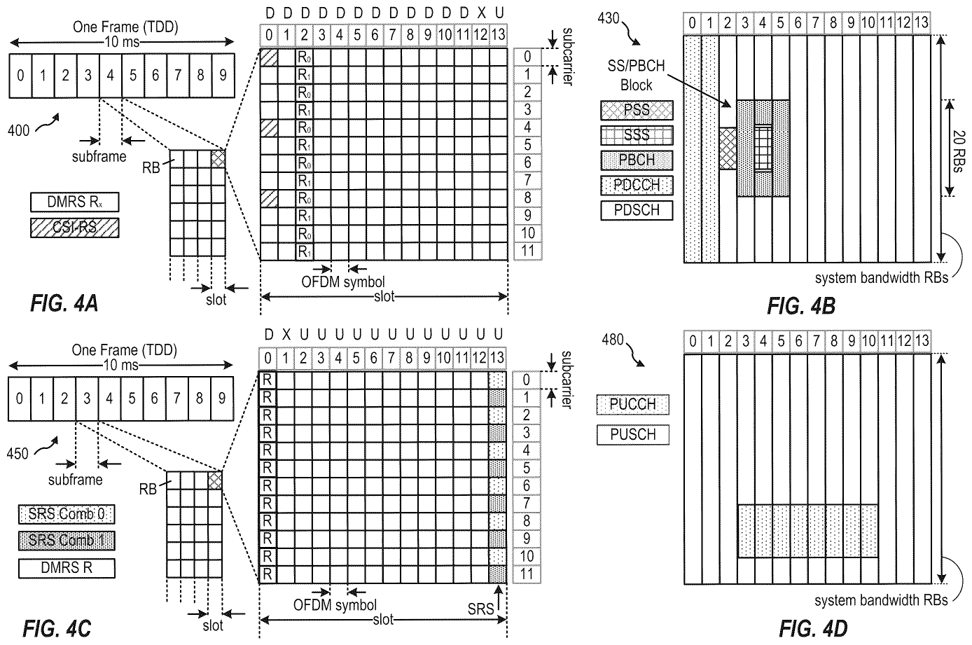

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example AI for Wireless Communications

Certain aspects described herein may be implemented, at least in part, using some form of AI, e.g., the process of using an ML model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

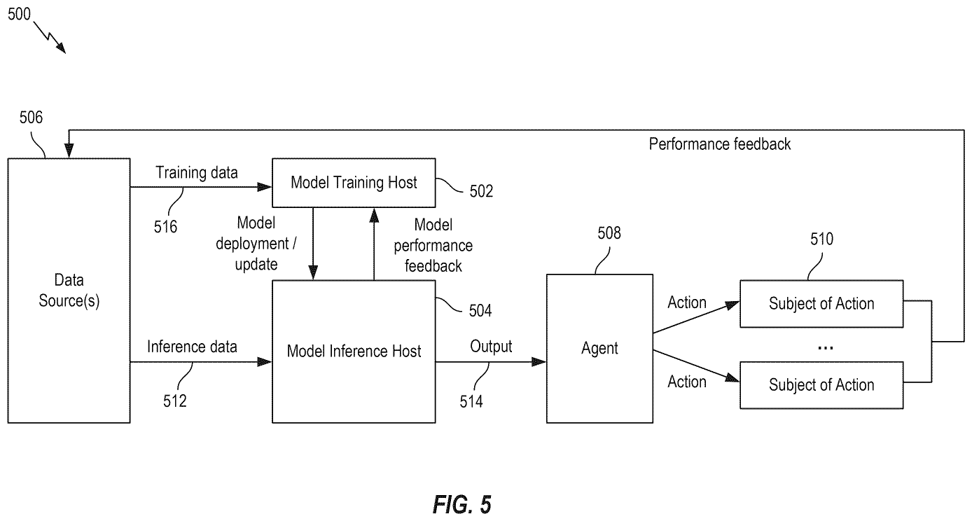

FIG. 5 is a diagram illustrating an example AI architecture 500 (simply referred to as “architecture 500”) that may be used for AI-enhanced wireless communications. As illustrated, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508.

The agent 508 may be an element or an entity of a wireless communication system including, for example, a radio access network (RAN), a wireless local area network, a device-to-device (D2D) communications system, etc. As an example, the agent 508 may be a user equipment (UE), a base station or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a DU or an RU and the output from model inference host 504 is associated with UE mobility, the agent 508 may determine whether to change or modify a serving cell based on the output 514. If the agent 508 determines to act based on the output 514, agent 508 may indicate the action to at least one subject of the action 510. For example, if the agent 508 determines to trigger a handover from a source cell to a target or candidate cell for a communication between the agent 508 and the subject of action 510 (e.g., a UE), the agent 508 may send a handover indication to the subject of action 510 (e.g., a UE). As another example, the agent 508 may be a UE, the output 514 from model inference host 504 may be one or more predicted neighbor cells for a handover. For example, the model inference host 504 may predict neighbor cells for a handover based on a trajectory of the UE. Based on the predicted neighbor cells, the agent 508, such as the UE, may send, to the subject of action 510, such as a BS, a request to perform a handover to at least one of the predicted neighbor cells. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, an ML model is deployed at or on a network entity for UE mobility prediction. More specifically, a model inference host, such as model inference host 504 in FIG. 5, may be deployed at or on the network entity for UE mobility predictions including candidate communication link(s) (e.g., candidate cells and/or beams), communication failure event prediction, measurement event prediction, etc.

In some aspects, an ML model is deployed at or on a UE for UE mobility prediction. More specifically, a model inference host, such as model inference host 504 in FIG. 5, may be deployed at or on the UE for candidate communication link(s) (e.g., candidate cells and/or beams), communication failure event prediction, measurement event prediction, etc.

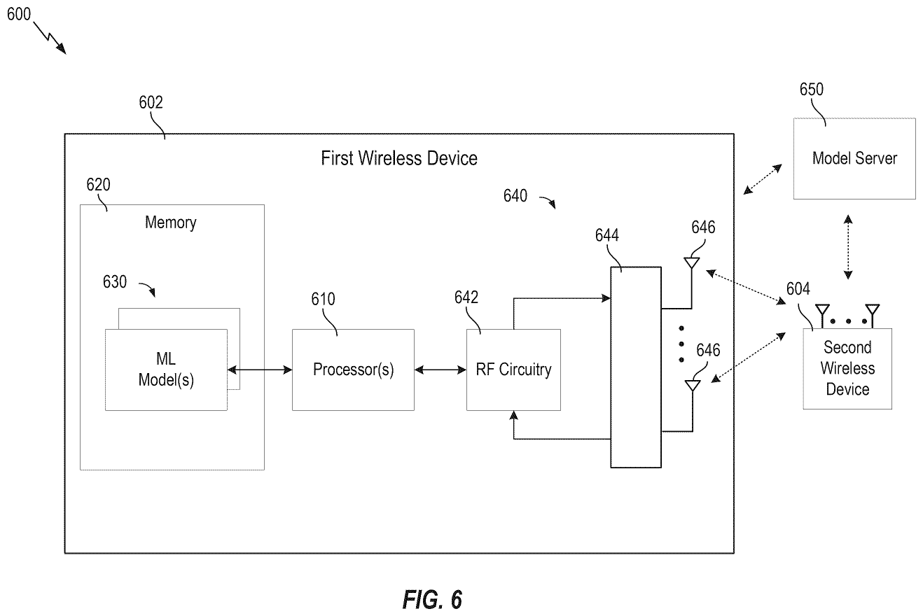

FIG. 6 illustrates an example AI architecture 600 of a first wireless device 602 that is in communication with a second wireless device 604. The first wireless device 602 may be the UE 104 as described herein with respect to FIGS. 1 and 3. Similarly, the second wireless device 604 may be a network entity (or disaggregated entity thereof) as described herein with respect to FIGS. 1 and 2. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the model inference host 504 of FIG. 5. The ML model 630 may be used to perform any of various AI-enhanced tasks, such as those listed above.

As an example, the ML model 630 may take UE location information (e.g., positioning coordinates over past period of time) as input to predict a trajectory of the UE and handover targets across the trajectory. The input data may include, for example, UE positions over time and serving cell(s) observed at each of the UE positions. The output data may include, for example, a UE trajectory prediction (e.g., latitude, longitude, altitude, over a future period of time). For example, the UE trajectory prediction may correspond to a morning and/or afternoon commute from home to work, or vice versa. Note that other input data and/or output data may be used in addition to or instead of the examples described herein.

In certain aspects, a model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example ML Model

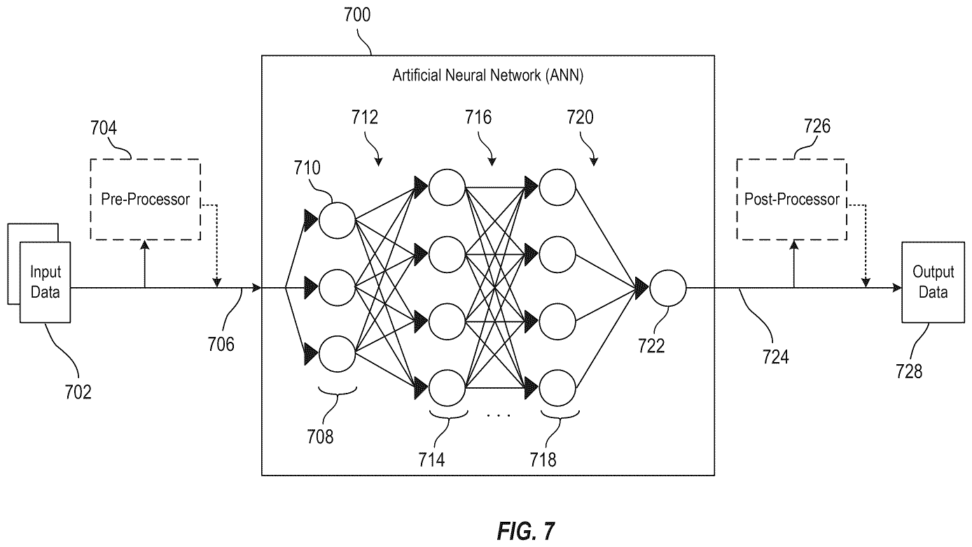

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Example of ML Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Example UE Mobility

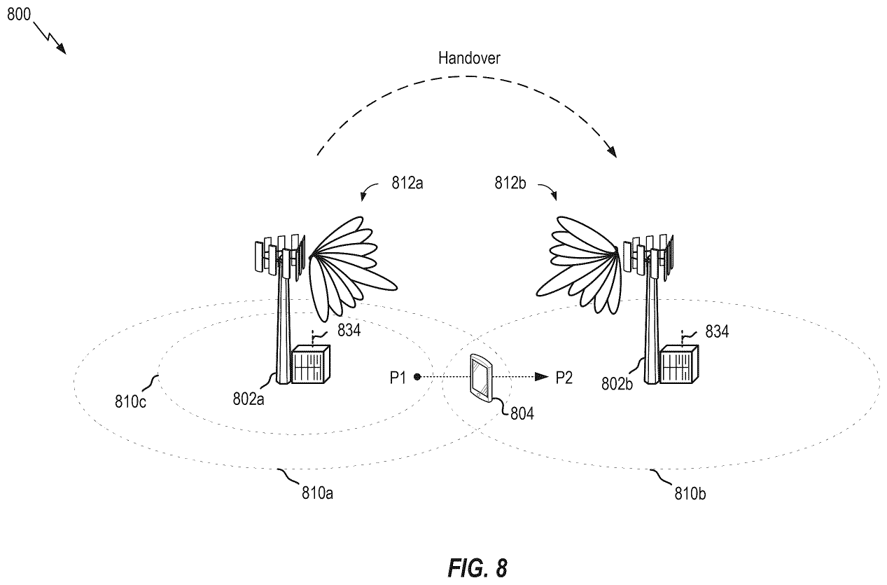

FIG. 8 depicts an example of UE mobility in a wireless communications network 800. In this example, the wireless communications network 800 may include a first network entity 802a, a second network entity 802b, and a UE 804. In certain aspects, the first network entity 802a and/or the second network entity 802b may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, UE 804 may be an example of UE 104 depicted and described with respect to FIG. 1 or the UE 304 depicted and described with respect to FIG. 3. However, in other aspects, UE 804 may be another type of wireless communications device and the first network entity 802a and/or the second network entity 802b may be another type of network entity or network node, such as those described herein. Note that any operations or signaling illustrated with dashed lines may indicate that that operation or signaling is an optional or alternative example.

The first network entity 802a may have a first coverage area 810a and the second network entity 802b may have a second coverage area 810b, which may overlap with the first coverage area 810a. The first network entity 802a may also have a third coverage area 810c. In certain aspects, the first coverage area 810a may form a first cell, the second coverage area 810b may form a second cell, and the third coverage area 810c may form a third cell. The first cell and third cell may form a first cell group, and the second cell may form a second cell group. The first network entity 802a may communicate via a first set of beams 812a, and the second network entity 802b may communicate via a second set of beams 812b.

Due to mobility (e.g., the UE 804 moving from the first coverage area 810a to the second coverage area 810b), the UE 804 may transition from communicating with the first network entity 802a via the first set of beams 812a to communicating with the second network entity 802b via the second set of beams 812b. As an example, the UE 804 may be located at a first position P1 in the first coverage area 810a and/or the third coverage area 810c at a first occasion (e.g., at a first time), and then the UE 804 may move to a second position P2 in the second coverage area 810b at a second, later occasion (e.g., a second time that is later in time than the first time).

In certain aspects, the UE 804 may send a measurement report to the first network entity 802a. The measurement report may indicate radio measurements (e.g., signal strengths) associated with the serving cell of the first network entity 802a and neighboring cell(s) of the second network entity 802b. In certain aspects, the measurement report may indicate the signal strengths associated with certain beam(s) of the serving cell and the neighboring cell(s), such as the first set of beams 812a and/or the second set of beams 812b. Based on the measurement report (e.g., indicating a stronger signal strength associated with radio measurements for the second network entity 802b relative to the first network entity 802a), the first network entity 802a may determine to handover communications with the UE 804 to the second network entity 802b. The first network entity 802a may be in communication with the second network entity 802b via a backhaul link 834 (e.g., an F1, Xn, and/or NG interface) in order to exchange information for the handover. In the context of a handover, the first network entity 802a may be referred to as a source network entity, which may represent a point of origin for the handover; and the second network entity 802b may be referred to as a target or candidate network entity, which may represent the destination for the handover.

In certain aspects, the UE 804 may, itself, perform the radio measurements associated with the serving cell of the first network entity 802a and the radio measurements associated with the neighboring cell(s) of the second network entity 802b (e.g., may perform actual measurements). For example, UE 804 may determine an RSRP, an RSSI, an RSRQ, an SNR, and/or an SINR, among others, for one or more reference signals obtained by UE 804 in the serving cell of the first network entity 802a and the neighboring cell(s) of the second network entity 802b. This may be referred to herein as a legacy measurement, such as a non-collaborative or non-cooperative measurement.

In certain aspects, one or more ML models may be deployed at or on UE 804 for radio measurement prediction. More specifically, UE 804 may utilize the one or more ML models to predict one or more measurements (e.g., generate one or more “measurement predictions”) associated with the serving cell of the first network entity 802a and/or associated with the neighboring cell(s) of the second network entity 802b. The ML model(s) may be used to generate such measurement prediction(s) based on data (e.g., real-time data) that UE 804 collects from its surrounding environment. As an illustrative example, in some cases, UE 804 may use the one or more ML models to predict future signal strength measurements for reference signals that may be communicated in the future in the serving cell of the first network entity 802a and/or the neighboring cell(s) of the second network entity 802b. Such predictions may be based on a measurement resource that occurs in the future. For example, the UE 804 may predict the future signal strength measurement for a reference signal to be transmitted on the measurement resource. The measurement resource may, or may not, eventually be used for a reference signal transmission or measurement.

The measurements and/or the measurement predictions may be included in the measurement report sent from UE 804 to first network entity 802a, such as to enable first network entity 802a to make a handover decision for UE 804.

In some cases, the handover may involve a CU/DU handover, such as inter-DU-intra-CU handover and/or inter-CU handover. For example, the handover may involve a handover from a source DU to a target or candidate DU in communication with a common CU. The handover may involve a handover from a source CU to a target or candidate CU. Accordingly, the first network entity 802a and/or the second network entity 802b may be an example of an RU, DU, and/or CU, which are all described in more detail in connection with FIG. 2.

In some examples described herein, measurement generation and reporting (e.g., with or without the use of one or more ML models) may be performed on a “per-UE” basis, meaning that a set of individual UEs connected to a network entity may be configured to carry out the measurement and reporting of radio measurements to the network entity. For example, in FIG. 8, two other UEs, in addition to UE 804, may also be connected to first network entity 802a (these other UEs are not shown in FIG. 8) when UE 804 is connected to first network entity 802a. These two other UEs may be positioned near UE 804 in the first coverage area 810a associated with first network entity 802a. For example, the two other UEs may be associated with a co-location condition with the UE 804 (e.g., based on being within a threshold distance of one another, historical similarity in reported measurements, being connected to the same micro cell, being in a same vehicle or building, or the like).

Each of the three UEs, including UE 804, may be configured to generate one or more measurements (e.g., actual measurement(s) and/or measurement prediction(s)) and report these measurement(s) to first network entity 802a. That is, UE 804 may generate and report, to first network entity 802a, first radio measurements, while the other UEs may also generate and report, to first network entity 802a, second and third radio measurements, respectively. Due to at least the UEs being positioned close in proximity to one another (e.g., due to satisfying of a co-location condition associated with the three UEs and based on the respective position of each UE in coverage area 810a), the measurements reported to first network entity 802a, from the three UEs may provide first network entity 802a with substantially duplicate information about the serving cell of the first network entity 802a. Specifically, each UE, while in close proximity to one another, may experience similar channel conditions; thus, the measurement(s) obtained and reported per UE may be the same or similar.

In some cases, the redundant measurement operations among the three UEs may use resources for performing such measurements and/or may increase power consumption among the UEs. Further, in some cases, the three UEs reporting duplicative measurement(s) to first network entity 802a (e.g., such as continuously or at fixed intervals) may contribute to a large amount of redundant information to be processed by first network entity 802a. Processing the identical or similar information associated with each UE may result in the network entity unnecessarily analyzing duplicated information multiple times, thereby leading to a waste of network resources and/or an unnecessary waste of power at first network entity 802a. Inefficient resource usage among first network entity 802a and the three UEs, including UE 804, may contribute to an overall reduction in capacity, coverage, and/or user experience for the network.

### Example UE Cooperative Operations for Measurement Generation and Reporting

One solution to overcoming the aforementioned technical problems associated with “per UE” measurement and reporting may leverage cooperative operations among UEs. UE cooperative operations may refer to techniques where multiple UEs communicate and collaborate with one another, such as to improve capacity and/or coverage in wireless communication networks. As used herein, UE cooperative operations may be utilized to enable communication and collaboration among UEs with respect to measurement generation and reporting. For example, instead of each UE individually generating measurement(s) and reporting its measurement(s) to a network entity, UEs that are co-located within a same area may collaborate to delegate and/or divide measurement, measurement prediction, and/or measurement reporting tasks among the UEs, such as to reduce redundant operations at the UEs and the reporting of redundant information to a network entity.

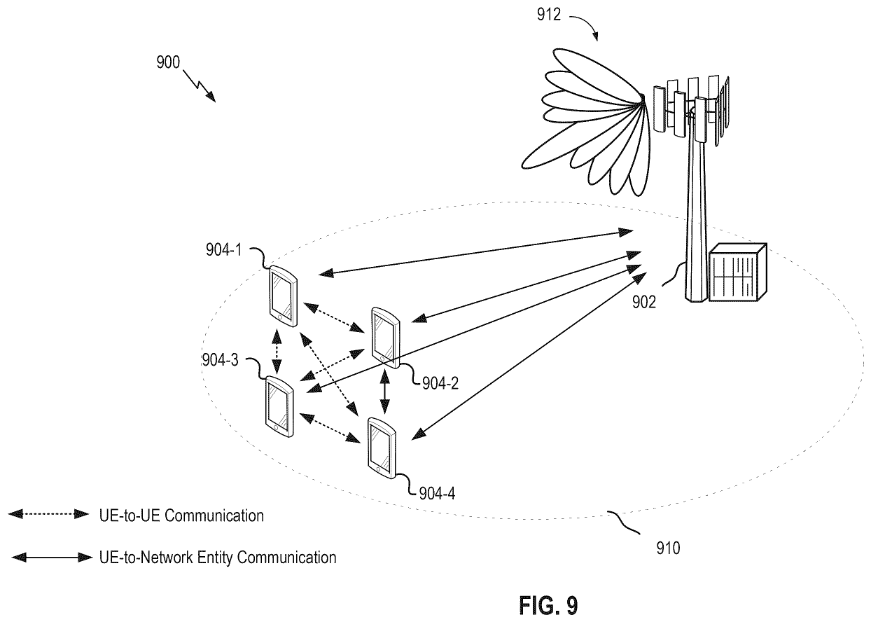

FIG. 9 depicts example UE cooperative operation, such as for measurement generation and reporting. As shown in FIG. 9, a wireless communications network 900 may include a network entity 902 having a coverage area 910. In certain aspects, the coverage area 910 may form a cell. The network entity 902 may communicate with other nodes, such as each of UEs 904-1, 904-2, 904-3, and 904-4 (collectively referred to herein as “UEs 904” and individually referred to herein as “UE 904”), via a set of beams 912.

In certain aspects, the network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, each of the UEs 904 may be an example of UE 104 depicted and described with respect to FIG. 1 or the UE 304 depicted and described with respect to FIG. 3. However, in other aspects, each of the UEs 904 may be another type of wireless communications device and network entity 902 may be another type of network entity or network node, such as those described herein. Note that any operations or signaling illustrated with dashed lines may indicate that that operation or signaling is an optional or alternative example.

In this example, UEs 904 may be connected to network entity 902. For example, each UE 904 may be positioned within coverage area 910 associated with network entity 902 and may communicate with network entity 902 via one or more beams of the set of beams 912.

UE 904-1 may be located at a first position P1 in the coverage area 910, UE 904-2 may be located at a second position P2 in the coverage area 910, UE 904-3 may be located at a third position P3 in the coverage area 910, and UE 904-4 may be located a four position P4 in the coverage area. Positions P1, P2, P3, and P4 of the UEs 904 in coverage area 910 may be close in proximity to one another. For example, positions P1, P2, P3, and P4 of the UEs 904 in coverage area 910 may satisfy a co-location condition (e.g., such as a distance between each pair of the positions P1, P2, P3, and P4 is less than a threshold distance, P1, P2, P3, and P4 fall within an area which may be defined by a diameter D, etc.), such that UEs 904 may form a group of UEs (e.g., a “cooperative group of UEs”) for performing UE cooperative operations.

In this example, the UEs 904 may perform cooperative operations for measurement generation and reporting, such as to enable UE 904-1 to report at least one measurement value to network entity 902. The UE cooperative operations related to measurement generation and reporting, which may be performed by UEs 904 (e.g., the cooperative group of UEs), may be referred as “actual or predicted cooperative measurements,” or more simply “cooperative measurement techniques.” One or more cooperative measurement techniques may be performed by UEs 904 to help reduce (or avoid) redundant operations at the UEs and/or the reporting of redundant information to network entity 902, such as to enable network entity 902 to make UE-specific handover decisions.

For example, a first cooperative measurement technique (referred to as “measurement delegation”) may include one or more delegate UEs performing actual measurement(s) on behalf of UE 904-1, and UE 904-1 sending, to network entity 902, at least one measurement value based on the actual measurement(s) by the delegate UE(s). More specifically, UE 904-1 may skip performing any measurements altogether. Instead, UE 904-2, UE 904-3, and/or UE 904-4 (e.g., “delegate UE(s)”) may be delegated to perform actual measurements on behalf of UE 904-1. UE 904-2, UE 904-3, and/or UE 904-4 may indicate these measurement(s) to UE 904-1, and UE 904-1 may send, to network entity 902, a measurement report based on the indicated measurement(s). Put differently, UE 904-1 may send, to network entity 902, at least one measurement value based on cooperative measurement output, where the cooperative measurement output includes output from the actual measurement(s) performed by delegate UE(s) 904-2, 904-3, and/or 904-4. Each delegate UE 904-2, 904-3, and/or 904-4 may be similar to UE 904-1 in terms of capabilities and may just be designated as a “delegate UE” based on agreement (and/or signaling) between the UEs 904 to perform the first cooperative measurement technique.

A second cooperative measurement technique (referred to as “measurement collaboration”) may include one or more collaborative UEs and UE 904-1 performing actual measurement(s), and UE 904-1 sending, to network entity 902, at least one measurement value based on the actual measurement(s) by the collaborative UE(s) and UE 904-1. For example, UE 904-1 in addition to UE 904-2, UE 904-3, and/or UE 904-4 (e.g., “collaborative UE(s)”) may each perform a respective partial measurement to derive full measurement data. UE 904-2, UE 904-3, and/or UE 904-4 may indicate their respective partial measurement to UE 904-1, and UE 904-1 may send, to network entity 902, a measurement report based on its partial measurement and the indicated partial measurement(s). Put differently, UE 904-1 may send, to network entity 902, at least one measurement value based on cooperative measurement output, where the cooperative measurement output includes output from the partial measurement(s) performed by collaborative UE(s) 904-2, 904-3, and/or 904-4 and UE 904-1. The partial measurements may be on different (e.g., adjacent) frequency resources, different time resources, or the like.

A third cooperative measurement technique (referred to as “measurement prediction based on measurement delegation”) may include UE 904-1 generating a measurement prediction based on the output from UEs 904 performing measurement delegation (e.g., the first cooperative measurement technique). UE 904-1 may send, to network entity 902, a measurement report based on the measurement prediction. Put differently, UE 904-1 may send, to network entity 902, at least one measurement value based on cooperative measurement output, where the cooperative measurement output includes the measurement prediction generated by UE 904-1.

A fourth cooperative measurement technique (referred to as “measurement prediction based on measurement collaboration”) may include UE 904-1 generating a measurement prediction based on the output from UEs 904 performing measurement collaboration (e.g., the second cooperative measurement technique). UE 904-1 may send, to network entity 902, a measurement report based on the measurement prediction. Put differently, UE 904-1 may send, to network entity 902, at least one measurement value based on cooperative measurement output, where the cooperative measurement output includes the measurement prediction generated by UE 904-1.

A fifth cooperative measurement technique (referred to as “measurement prediction delegation”) may include one or more delegate UEs generating measurement predictions(s) for UE 904-1, and UE 904-1 sending, to network entity 902, at least one measurement value based on the measurement prediction(s) by the delegate UE(s). More specifically, UE 904-1 may skip performing any measurement predictions altogether. Instead, UE 904-2, UE 904-3, and/or UE 904-4 (e.g., “delegate UEs”) may be delegated to generate measurement prediction(s) on behalf of UE 904-1. UE 904-2, UE 904-3, and/or UE 904-4 may indicate these measurement prediction(s) to UE 904-1, and UE 904-1 may send, to network entity 902, a measurement report based on the indicated measurement prediction(s). Put differently, UE 904-1 may send, to network entity 902, at least one measurement value based on cooperative measurement output, where the cooperative measurement output includes the measurement prediction(s) generated by delegate UE(s) 904-2, 904-3, and/or 904-4.

A sixth cooperative measurement technique (referred to as “measurement prediction collaboration”) may include one or more collaborative UEs and UE 904-1 jointly performing measurement prediction. For example, UE 904-1 in addition to UE 904-2, UE 904-3, and/or UE 904-4 (e.g., “collaborative UE(s)”) may each perform a respective partial measurement prediction to derive full measurement data. UE 904-2, UE 904-3, and/or UE 904-4 may indicate their respective partial measurement prediction to UE 904-1, and UE 904-1 may send, to network entity 902, a measurement report based on its partial measurement prediction and the indicated partial measurement prediction(s). Put differently, UE 904-1 may send, to network entity 902, at least one measurement value based on cooperative measurement output, where the cooperative measurement output includes the partial measurement prediction(s) generated by collaborative UE(s) 904-2, 904-3, and/or 904-4 and UE 904-1.

### Aspects Related to UE Configuration for Utilizing Cooperative Measurement Technique(s) for Measurement Generation and Reporting

Aspects described herein improve upon the state of the art by providing techniques for configuring a UE to utilize (1) a combination of two or more cooperative measurement techniques or (2) a combination of one or more cooperative measurement techniques and legacy measurement(s) at the UE, such as for measurement generation and reporting.

A UE configured to utilize a cooperative measurement technique for measurement generation and reporting may (1) obtain cooperative measurement output that includes measurement(s) from one or more other UEs (e.g., of a cooperative group of UEs that includes the UE), (2) obtain measurement prediction(s) from one or more other UEs (e.g., of a cooperative group of UEs that includes the UE), and/or (3) generate one or more measurement predictions. Thus, where the UE is configured to utilize a combination of two or more cooperative measurement techniques, as described herein, the UE may obtain any combination of the aforementioned cooperative measurement output. The UE may be configured to report, to a network entity, at least one measurement value based on this combination of cooperative measurement output.

As another example, a UE configured to utilize legacy measurement(s) at the UE may perform one or more measurements itself. Thus, where the UE is configured to utilize a combination of one or more cooperative measurement techniques and legacy measurement(s) at the UE, as described herein, the UE may obtain any of the aforementioned cooperative measurement output(s) and legacy measurement(s). The UE may be configured to report, to a network entity, at least one measurement value based on this combination of cooperative measurement output and the legacy measurement(s).

In both cases, measurements and/or measurement predictions from multiple UEs may be combined and reported to the network entity, as one or more measurement value(s), in a single measurement report. Thus, improved network efficiency and reduced power consumption (e.g., at the network entity and/or one or more of the UEs) may be realized. For example, instead of performing measurement generation and reporting on a “per-UE” basis, the UEs may communicate and collaborate to send a single measurement report to the UE. Accordingly, the transmission of redundant information by the UEs and the processing of redundant information by the network may be avoided, thereby improving resource usage and/or power consumption at the wireless devices.

### Example Signaling for Measurement Generation and Reporting

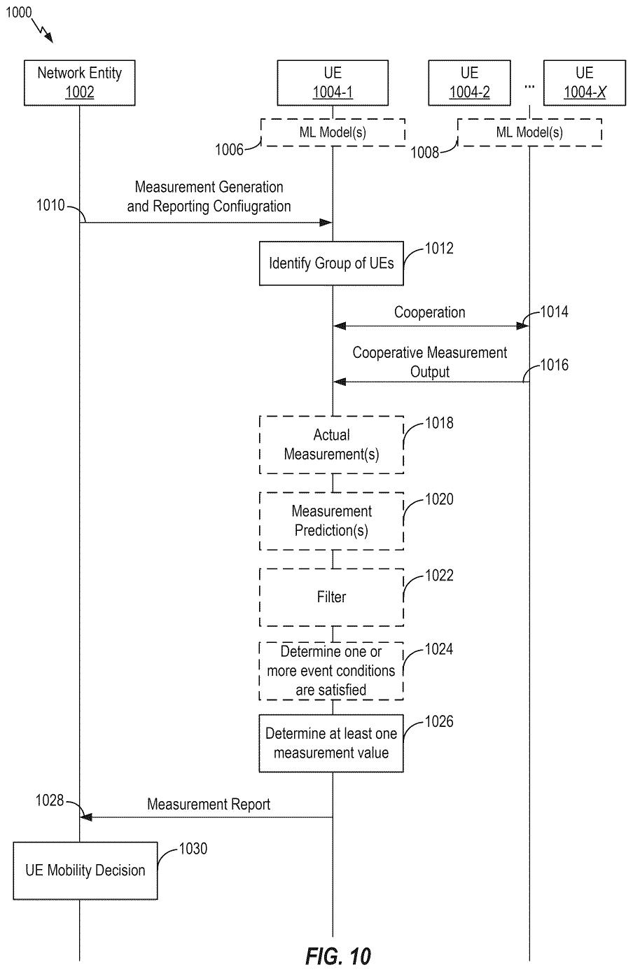

FIG. 10 depicts a process flow 1000 for communications in a network between a network entity 1002 and multiple UEs 1004-1 through 1004-X (collectively referred to herein as “UEs 1004” and individually referred to herein as “UE 1004”, and where X is an integer greater than 1). In certain aspects, the network entity 1002 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, each of the UEs 1004 may be an example of UE 104 depicted and described with respect to FIG. 1 or the UE 304 depicted and described with respect to FIG. 3. However, in other aspects, each of the UEs 1004 may be another type of wireless communications device and network entity 1002 may be another type of network entity or network node, such as those described herein. Note that any operations or signaling illustrated with dashed lines may indicate that that operation or signaling is an optional or alternative example.

In certain aspects, process flow 1000 may be used to configure UE 1004-1 to utilize cooperative measurement technique(s) for measurement generation and reporting. For example, in certain aspects, process flow 1000 may be used to configure UE 1004-1 to utilize a combination of two or more cooperative measurement techniques for measurement generation and reporting. In certain other aspects, process flow 1000 may be used to configure UE 1004-1 to utilize one or more cooperative measurement techniques and legacy measurement(s) at the UE for measurement generation and reporting.

In process flow 1000, UE 1004-1 may represent a UE that is configured to report measurement value(s) to network entity 1002. In certain aspects, the measurement value(s) reported by UE 1004-1 may be based on one or more cooperative measurement techniques performed by UEs 1004. That is, UEs 1004 may be positioned close in proximity to one another (e.g., a co-location condition may be satisfied for the UEs based on the respective position of each UE for a time period), and therefore, create a cooperative UE group for performing one or more cooperative measurement techniques. Thus, in certain aspects, UEs 1004-2 through 1004-X may represent delegate UEs used to perform cooperative measurement technique(s). Further, in certain aspects, UEs 1004-2 through 1004-X may represent collaborative UEs used to perform cooperative measurement technique(s).

In certain aspects, as shown at 1006 in FIG. 10, UE 1004-1 may be configured with one or more ML models, such as preconfigured, or as received from another wireless device. Additionally or alternatively, in certain aspects, as shown at 1008 in FIG. 10, UEs 1004-2 through 1004-X may have one or more ML models deployed at or on UEs 1004-2 through 1004-X (e.g., one or more respective ML models per UE among UEs 1004-2 through 1004-X). For example, where UEs 1004 are configured to perform cooperative measurement techniques, such as (1) measurement prediction based on measurement delegation, (2) measurement prediction based on measurement collaboration, (3) measurement prediction delegation, and/or (4) measurement prediction collaboration, one or more ML models may be implemented at the UEs 1004.

The ML model(s) deployed at or on UEs 1004 may be used for measurement prediction generation. More specifically, ML model(s) implemented at a UE 1004 be utilized by the UE 1004 to predict one or more radio measurements. In certain aspects, the radio measurements predicted by the UE 1004 may include L1 measurements and/or L3 measurements. In certain aspects, the radio measurements predicted by the UE 1004 may include RRM measurements (e.g., measurements that may include L1 or L3 measurements). Example L1 measurements may include RSRP, RSSI, RSRQ, SNR, and/or SNR measurements, among others, for one or more reference signals. Example L3 measurements may include packet loss, latency, throughput, and/or jitter measurements, among others. In certain aspects, a measurement prediction generated by a UE 1004 may include a temporal domain prediction, a spatial domain prediction, or a spatiotemporal domain prediction.

Process flow 1000 begins, at 1010, with network entity 1002 sending, to UE 1004-1, a measurement generation and reporting configuration. The measurement generation and reporting configuration may comprise signaling used to configure UE 1004-1 to report at least one measurement value to network entity 1002. More specifically, the signaling may configure UE 1004-1 to report at least one measurement value that is based on, at least, cooperative measurement output, which may be generated based on UEs 1004 performing at least one cooperative measurement technique (e.g., described above with respect to FIG. 9).

For example, in certain aspects, the measurement generation and reporting configuration may configure UE 1004-1 to utilize a combination of two or more cooperative measurement techniques to generate cooperative measurement output. For example, the measurement generation and reporting configuration may configure UE 1004-1 to perform (1) measurement delegation and measurement collaboration (2) measurement delegation and measurement prediction based on measurement delegation, (3) measurement collaboration and measurement prediction based on measurement collaboration, (4) measurement prediction delegation and measurement prediction collaboration, and/or (5) any other combination of cooperative measurement techniques with UEs 1004-2 through 1004-X, such as to generate the cooperative measurement output. Further, the measurement generation and reporting configuration may configure UE 1004-1 to send, to network entity 1002, at least one measurement value that is based on the cooperative measurement output.

In certain other aspects, the measurement generation and reporting configuration may configure UE 1004-1 to utilize one or more cooperative measurement techniques and legacy measurement(s) at the UE to generate cooperative measurement output and one or more legacy measurements. For example, the measurement generation and reporting configuration may configure UE 1004-1 to perform one or more measurements itself (e.g., “legacy measurement(s)”). Further, the measurement generation and reporting configuration may configure UE 1004-1 to perform (1) measurement delegation and measurement collaboration, (2) measurement delegation and measurement prediction based on measurement delegation, (3) measurement collaboration and measurement prediction based on measurement collaboration, (4) measurement prediction delegation and measurement prediction collaboration, and/or (5) any other combination of cooperative measurement techniques with UEs 1004-2 through 1004-X, such as to generate the cooperative measurement output. Further, the measurement generation and reporting configuration may configure UE 1004-1 to send, to network entity 1002, at least one measurement value that is based on the cooperative measurement output and the output from the one or more legacy measurements.

In certain aspects, the measurement generation and reporting configuration may configure UE 1004-1 to report the cooperative measurement output, generated based on performing a combination of two or more cooperative measurement techniques, as multiple measurement values. Put differently, UE 1004-1 may be configured to report the measurement output from each of the two or more cooperative measurement techniques. Thus, the UE 1004-1 may be configured to report at least one measurement value as a plurality of measurement values (e.g., multiple measurement values) based on the output from each of the two or more cooperative measurement techniques.

As an illustrative example, where UEs 1004 perform (1) measurement delegation and (2) measurement prediction delegation, UE 1004-1 may be configured to report, to network entity 1002, output from the measurement delegation and output from the measurement prediction delegation as multiple measurement value(s). Specifically, the multiple measurement values may include (1) output from one or more measurements performed by one or more delegate UEs 1004-2 through 1004-X (e.g., output from each measurement) and (2) output from one or more measurement predictions generated by the one or more delegate UEs 1004-2 through 1004-X (e.g., output from each measurement prediction).

In certain aspects, the measurement generation and reporting configuration may configure UE 1004-1 to report the cooperative measurement output, generated based on performing at least one cooperative measurement technique, and output from performing the legacy measurement(s) as multiple measurement values. Put differently, UE 1004-1 may be configured to report the measurement output from each of the cooperative measurement techniques used, as well as the legacy measurement output from legacy measurement(s) performed by UE 1004-1. Thus, the UE 1004-1 may be configured to report the at least one measurement value as a plurality of measurement values (e.g., multiple measurement values), which are based on the output from one or more cooperative measurement techniques and legacy measurement(s) at the UE 1004-1.

In certain aspects where the UE 1004-1 is configured to report multiple measurement values, each measurement value reported to the network entity 1002 may be labeled. The label accompanying each measurement value may indicate whether a legacy measurement and/or a cooperative measurement technique is associated with (e.g., was used to generate) the specific measurement value. If the label indicates that a measurement value is associated with a cooperative measurement technique, then the label may further indicate which cooperative measurement technique is associated with (e.g., was used to generate) the measurement value. For example, a first measurement value may have a first label indicating that the first measurement value is associated with measurement delegation (e.g., one example cooperative measurement technique), while a second measurement value may have a second label indicating that the second measurement value is associated with measurement prediction delegation (e.g., another example cooperative measurement technique).

In certain aspects, the measurement generation and reporting configuration may configure UE 1004-1 to report the cooperative measurement output, generated based on performing a combination of two or more cooperative measurement techniques, as a single measurement value. For example, the UE 1004-1 may be configured to determine the single measurement value based on combining the cooperative measurement output from the two or more cooperative measurement techniques and report the single measurement value as the at least one measurement value.

In certain aspects, the measurement generation and reporting configuration may configure UE 1004-1 to report the cooperative measurement output and legacy measurement output, generated based on performing one or more cooperative measurement techniques and legacy measurement(s) (e.g., at UE 1004-2), as a single measurement value. For example, the UE 1004-1 may be configured to determine the single measurement value based on combining the cooperative measurement output from the one or more cooperative measurement techniques and the output from the legacy measurement(s), and further report the single measurement value as the at least one measurement value.

In certain aspects, UE 1004-1 may combine cooperative measurement output from two or more cooperative measurement techniques based on a respective weight associated with each cooperative measurement technique. For example, different weights may be associated with different cooperative measurement techniques, such that outputs from different cooperative measurement techniques contribute more or less than outputs from other cooperative measurement techniques when determining the single measurement value. As an illustrative example, a first weight (W1) may be associated with first output generated based on performing measurement delegation, and a second weight (W2) may be associated with second output generated based on performing measurement prediction delegation. The single measurement value may be determined based on performing a weighted average calculation, or more specifically, multiplying output from each cooperative measurement technique by its associated weight, adding the products of this multiplication, and then dividing this sum by the sum of the weights:

$$Single Measurement Value = \frac{[ ( W 1 * first output ) + ( W 2 * second output ) ]}{W 1 + W 2}$$

In cases where more than one delegate UE 1004 is used to generate the first output, the first output, in the equation above, may be the average of the measurement output from the delegate UEs 1004. Similarly, in cases where more than one delegate UE 1004 is used to generate the second output, the second output, in the equation above, may be the average of the measurement prediction output from the delegate UEs 1004.

In certain aspects, UE 1004-1 may receive signaling from the network entity 1002 indicating the respective weight associated with each cooperative measurement technique (not shown in FIG. 10), such that the UE 1004-1 may use these weights to determine the single measurement value. In certain other aspects, UE 1004-1 may determine the respective weight associated with each cooperative measurement technique, such that the UE 1004-1 may use these weights to determine the single measurement value. For example, UE 1004-1 may autonomously select the weights that may be associated with each cooperative measurement technique. Selection of the respective weight per cooperative measurement technique may be based on (1) external information received by UE 1004-1 (e.g., via one or more application programming interface (API) messages), (2) a predicted data confidence level and/or accuracy associated with each cooperative measurement technique, and/or (3) one or more historical mobility-related statistics (e.g., a number and/or rate of handover success(es), a number and/or rate of handover failure(s), a number and/or rate of ping-pong handover(s), etc.), among other factors. In certain aspects, the respective weight associated with each cooperative measurement technique may be different from one another. In certain aspects, the respective weight associated with each cooperative measurement technique, for at least two of the cooperative measurement techniques, may be the same as one another.

In certain aspects, UE 1004-1 may combine cooperative measurement output from two or more cooperative measurement techniques based on a respective contribution percentage associated with each cooperative measurement technique. For example, different contribution percentages may be associated with different cooperative measurement techniques, such that outputs from different cooperative measurement techniques contribute more or less than outputs from other cooperative measurement techniques when determining the single measurement value. In certain aspects, the contribution percentage may control how many samples (e.g., output) and/or which samples from each different cooperative measurement technique may be selected and used to determine the single measurement value.

As an illustrative example, a first contribution percentage=80% may be associated with first output (e.g., a first set of samples/output from multiple delegates UEs) generated based on performing measurement delegation and a second contribution percentage=20% may be associated with second output (e.g., a second set of samples/output from multiple delegates UEs) generated based on performing measurement prediction delegation. When determining the single measurement value (e.g., to be reported by UE 1004-1), UE 1004-1 may take into consideration the contribution percentage of each cooperative measurement technique such that (1) 80% of the first output associated with performing measurement delegation (e.g., 80% of the measurements from the delegate UEs) contributes towards determining the single measurement value and (2) 20% of the second output associated with performing measurement prediction delegation (e.g., 20% of the measurement predictions from the delegate UEs) contributes towards determining the single measurement value.

In certain aspects, UE 1004-1 may receive signaling from the network entity 1002 indicating the respective contribution percentage associated with each cooperative measurement technique (not shown in FIG. 10), such that the UE 1004-1 may use these contribution percentages to determine the single measurement value. In certain aspects, instead of explicit contribution percentages being indicated to UE 1004-1, an accuracy threshold may be signaled from network entity 1002 to UE 1004-1. The accuracy threshold may represent a minimum accuracy that may be tolerated for the single measurement value. In such cases, UE 1004-1 may determine the respective contribution percentage associated with each cooperative measurement technique based on the accuracy threshold. In certain other aspects, UE 1004-1 may determine the respective contribution percentage associated with each cooperative measurement technique (e.g., not based on an indicated accuracy threshold), such that the UE 1004-1 may use these contribution percentages to determine the single measurement value. For example, UE 1004-1 may autonomously select the contribution percentages that may be associated with each cooperative measurement technique.

In certain aspects, UE 1004-1 may autonomously determine other parameters that may be associated with different cooperative measurement techniques such that these parameters may be used for determining the single measurement value.

In certain aspects, UE 1004-1 may use both weights and contribution percentages associated with different cooperative measurement technique when combining output from two or more cooperative measurement techniques performed by UEs 1004. For example, where two cooperative measurement techniques are used, UE 1004-1 may (1) determine a first subset of samples, from the first cooperative measurement technique, to use based on a first contribution percentage associated with the first cooperative measurement technique and (2) then apply a first weight, associated with the first cooperative measurement technique, to the first subset of samples. Further, UE 1004-1 may (1) determine a second subset of samples, from the second cooperative measurement technique, to use based on a second contribution percentage associated with the second cooperative measurement technique and (2) then apply a second weight, associated with the second cooperative measurement technique, to the second subset of samples. The single measurement value may be based on the weighted output associated with the first subset of samples and the weighted output associated with the second subset of samples.

In certain aspects, the respective weight associated with each cooperative measurement technique may be determined based on the accuracy of the measurements/predictions, associated with each cooperative measurement technique, in a larger time scale. For example, the accuracy of the measurements/predictions generated for a cooperative measurement technique may be determined by comparing the measurements/predictions against an actual measurement performed by UE 1004-1 itself (e.g., not a cooperative measurement via a cooperative measurement technique).

In certain aspects, the contribution percentage may be determined in a smaller time scale based the available samples from each cooperative measurement technique. In some cases where a small amount of output samples (e.g., output measurement/predictions) are generated for a first cooperative measurement technique, then the contribution percentage associated with the first cooperative measurement technique may be smaller or reduced; however, the weight associated with the first cooperative measurement technique may stay the same (e.g., remain unchanged, such as from when a larger number of output samples are produced for the same first cooperative measurement method).

In certain aspects, UE 1004-1 may combine cooperative measurement output, from one or more cooperative measurement techniques, and output from the legacy measurement(s) at UE 1004-1 based on the weights, contribution percentages, and/or other parameters described in detail above (and used to combine cooperative measurement output from two or more cooperative measurement techniques).

In certain aspects, the measurement generation and reporting configuration may configure UE 1004-1 to perform sample filtering (e.g., filtering where samples that do not satisfy a threshold (e.g., are above or below the threshold) are dropped and samples that do satisfy a threshold are kept and used for measurement generation and reporting). For example, in certain aspects, UE 1004-1 may be configured to remove a subset of cooperative measurement output and/or legacy measurement output that does not satisfy one or more sample filtering thresholds. In certain aspects, UE 1004-1 may be configured to perform such sample filtering prior to reporting cooperative measurement output and/or legacy measurement output as a plurality of measurement values (e.g., also based on the configuration), In certain aspects, UE 1004-1 may be configured to perform such sample filtering prior to determining a single measurement based on the cooperative measurement output and/or legacy measurement output and reporting the single measurement value.

Sample filtering thresholds refer to minimum and/or maximum threshold values that may be used to remove outlier output data from cooperative measurement output and/or legacy measurement output. For example, a minimum sample filter threshold may be used to identify output data that is below an acceptable value, while a maximum sample filter threshold may be used to identify output data that is above an acceptable value, such that this identified data may be removed prior to reporting measurement value(s) to network entity 1002.

In certain aspects, UE 1004-1 may be configured to use a first minimum sample filtering threshold and/or a first maximum sample filtering threshold, where both thresholds are associated with actual measurement outputs from actual measurements by UE 1004-1. In certain aspects, UE 1004-1 may be configured to compare legacy measurement output to the first minimum sample filtering threshold and/or the first maximum sample filtering threshold, such as to remove any outliers in the data that do not satisfy the first filter minimum sample filtering threshold and/or the first maximum sample filtering threshold (e.g., output that is below the first filter minimum sample filtering threshold and/or above the first maximum sample filtering threshold).

Additionally, in certain aspects, UE 1004-1 may be configured to use a second minimum sample filtering threshold and/or a second maximum sample filtering threshold, where both thresholds are associated with actual measurement outputs from actual measurements by UE 1004-1 and/or UEs 1004-2 through 1004-X. In certain aspects, UE 1004-1 may be configured to compare cooperative measurement output generated based on the performance of (1) measurement delegation and/or (2) measurement collaboration to the second minimum sample filtering threshold and/or the second maximum sample filtering threshold. This comparison may be used to remove any outliers in the cooperative measurement output that do not satisfy the second minimum sample filtering threshold and/or the second maximum sample filtering threshold (e.g., output that is below the second minimum sample filtering threshold and/or above the second maximum sample filtering threshold).

Further, in certain aspects, UE 1004-1 may be configured to use a third minimum sample filtering threshold and/or a third maximum sample filtering threshold, where both thresholds are associated with predicted measurement outputs from measurement predictions performed by UE 1004-1 and/or UEs 1004-2 through 1004-X. In certain aspects, UE 1004-1 may be configured to compare cooperative measurement output, generated based on the performance of (1) measurement prediction based on measurement delegation, (2) measurement prediction based on measurement collaboration, (3) measurement prediction delegation, and/or (4) measurement prediction collaboration, to the third minimum sample filtering threshold and/or the third maximum sample filtering threshold. This comparison may be used to remove any outliers in the cooperative measurement output that do not satisfy the third minimum sample filtering threshold and/or the third maximum sample filtering threshold (e.g., output that is below the third minimum sample filtering threshold and/or above the third maximum sample filtering threshold).

In certain aspects, the measurement generation and reporting configuration may configure UE 1004-1 to apply filtering techniques to “smooth” or “filter” cooperative measurement output and/or legacy measurement output generated at different time instances over a period of time. As used herein, “smoothing” or “filtering” may be used to describe techniques for reducing noise and/or fluctuations in the measurement output. In certain aspects, the filtering techniques used for smoothing measurement output may involve the application of a digital filter to the measurement output. For example, the UE may use an FIR filter for FIR filtering or an IIR filter for IIR filtering. In certain aspects, UE 1004-1 may be configured to apply such filtering to smooth cooperative measurement output and/or legacy measurement output prior to reporting cooperative measurement output and/or legacy measurement output as a plurality of measurement values (e.g., also based on the configuration), In certain aspects, UE 1004-1 may be configured to apply such filtering to smooth cooperative measurement output and/or legacy measurement output prior to determining a single measurement based on the cooperative measurement output and/or legacy measurement output and reporting the single measurement value.

In certain aspects, UE 1004-1 may apply such filtering for measurement generation and reporting to improve the reliability and accuracy of network measurements that may change over time, such as due to changing network conditions (e.g., different network congestion, latency, interference, etc. may be experienced at different times). For example, cooperative measurement output and/or legacy measurement output obtained over a period of time may fluctuate and thus, may include inconsistencies and/or sudden spikes. In an effort to smooth such output, to help ensure that the cooperative measurement output and/or legacy measurement output reflects accurate output for the wireless communications network, UE-1004 may apply this filtering.

In certain aspects, the application of such filtering techniques may involve applying smoothing (e.g., filtering) each measurement output (e.g., generated as a legacy measurement and/or generated as part of a cooperative measurement technique) and/or prediction output (e.g., generated as part of a cooperative measurement technique) that may be used for measurement generation and reporting. For example, for each measurement/prediction output (e.g., associated with a specific time instance), a filter (e.g., a digital filter) may be used to produce a “smoothed” measurement/prediction output, also referred to as a “filtered” measurement/prediction output, that is influenced by the measurement/prediction output (e.g., for the specific time instance) and previous measurement/prediction output(s) (e.g., previously smoothed measurement output(s) and/or prediction output(s)). The amount of influence that the previous measurement/prediction output(s) have on the “smoothed” measurement/prediction output may be based on one or more filter coefficients.

As an illustrative example, UE 1004-1 may apply a filter to a measurement output, generated by a delegate UE at a first time instance during measurement delegation, to produce a smoothed measurement output. The smoothed measurement output may be based on the measurement output, from the delegate UE and associated with first time instance, and one or more measurement outputs and/or one or more prediction outputs generated earlier in time than the first time instance. The influence each previous measurement and/or prediction output has on the smoothed measurement output may be based on one or more filter coefficients.

In certain aspects, different filter coefficients may be applied to different measurement and/or predictions outputs. For example, when applying such filtering techniques, UE 1004-1 may be configured to (1) apply a first filter coefficient to actual measurement outputs from actual measurements by UE 1004-1, (2) apply a second filter coefficient to actual measurement outputs from actual measurements by UEs 1004-2 through 1004-X (e.g., actual measurements by other UEs), and (3) apply a third filter coefficient to predicted measurement outputs from measurement predictions performed by UE 1004-1 and/or UEs 1004-2 through 1004-X. Thus, the influence that past (e.g., earlier in time) actual measurement outputs from UE 1004-1, actual measurement outputs from other UEs 1004-2 through 1004-X, and/or predicted measurement outputs from UE 1004-1 and/or other UEs 1004-2 through 1004-X have on producing a “smoothed” measurement/prediction output may vary (e.g., the first filter coefficient may be different than the second and third filter coefficients, and/or the second filter coefficient may be different than the third filter coefficient).

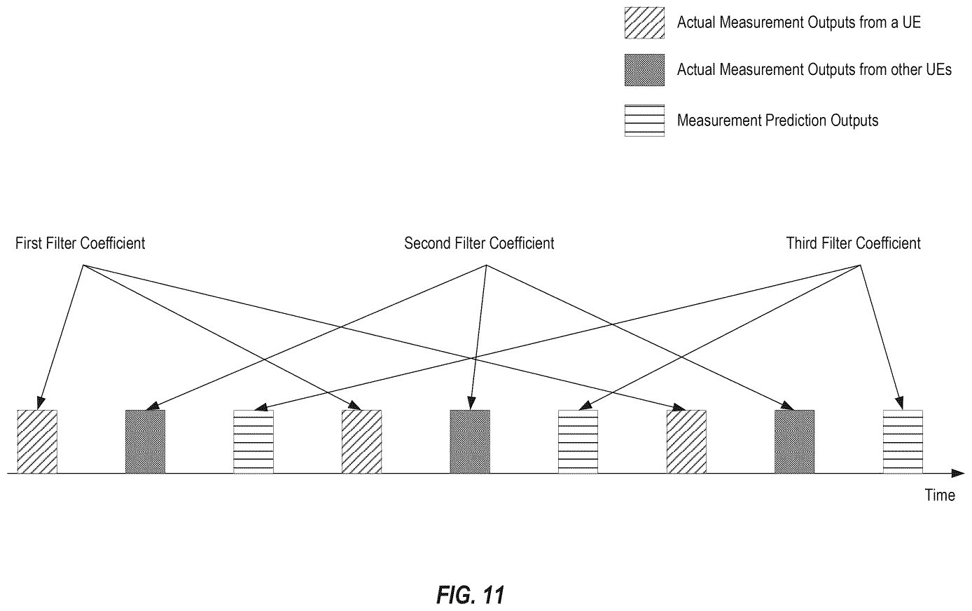

FIG. 11 depicts example filter coefficients that may be used for filtering, such as to smooth cooperative measurement output and/or legacy measurement output prior to measurement reporting. As shown in FIG. 11, a first filter coefficient may be applied to actual measurement outputs from a UE (e.g., samples generated at different time instances by the UE), such as UE 1004-1 in FIG. 10. A second filter coefficient may be applied to actual measurement outputs from other UEs (e.g., samples generated at different time instances by the other UEs), such as UE(s) 1004-2 through 1004-X in FIG. 10, which may be delegate UE(s) and/or collaborative UE(s). A third filter coefficient may be applied to measurement prediction outputs from the UE and/or the other UEs (e.g., samples generated at different time instances by the UE and/or the other UEs), such as UE 1004-1 and/or UE(s) 1004-2 through 1004-X in FIG. 10. Application of the three filter coefficients may allow for the removal of outlier measurement output, such as to help improve the accuracy of measurement value(s) reported to a network entity.

Returning to FIG. 10, in certain aspects, UE 1004-1 may obtain, from network entity 1002, an indication of at least one of the first filter coefficient, the second filter coefficient, or the third filter coefficient (not shown in FIG. 10). In certain aspects, UE 1004-1 may be configured to select at least one of the first filter coefficient, the second filter coefficient, or the third filter coefficient, such as any arbitrary value (e.g., referred to herein as “unrestricted selection”). In some other cases, UE selection of the first filter coefficient, the second filter coefficient, and/or the third filter coefficient threshold may be restricted. For example, in some cases, UE 1004-1 may further obtain, from network entity 1002 (not shown in FIG. 10), an indication of a first set of filter coefficients associated with a first measurement output type (e.g., actual measurement outputs from actual measurements by UE 1004-1), a second set of filter coefficient thresholds associated with a second measurement output type (e.g., actual measurement outputs by other UEs 1004-2 through 1004-X), and/or a third set of filter coefficient thresholds associated with the third measurement output type (e.g., predicted measurement outputs from measurement predictions performed by UE 1004-1 and/or UEs 1004-2 through 1004-X). In certain aspects, the UE 1004-1 may select the first filter coefficient from the indicated first set of filter coefficients. In certain aspects, the UE 1004-1 may select the second filter coefficient from the indicated second set of filter coefficients. In certain aspects, the UE 1004-1 may select the third filter coefficient from the indicated third set of filter coefficients. In some other cases, the UE 1004-1 may select the first filter coefficient, the second filter coefficient, and/or the third filter coefficient from a set of first filter coefficient, a second set of filter coefficients, and/or a third set of filter coefficients, respectively, which are defined in wireless communications standards (e.g., 3GPP specifications).

In certain aspects, different filter coefficient(s) may also be applied to the cell level measurement derivation from beam level measurement (i.e. weighted average instead of linear average). For example, cooperative and/or legacy measurement output(s) and/or prediction output(s) may be associated with a particular beam. Thus, a cell level measurement output and/or prediction output may involve UE combining the beam-level data. Here, the application of filtering (e.g., for “smoothing”), which may be performed using different filter coefficients, may be used to combine the beam-level data to generate the cell-level data.

In certain aspects, the measurement generation and reporting configuration may configure UE 1004-1 to perform measurement reporting in accordance with one or more event conditions. Put differently, the measurement generation and reporting configuration may configure UE 1004-1 to send measurement value(s) to network entity 1002 based on the satisfaction of one or more event conditions that are defined via the configuration.

In certain aspects, an event condition may be based on (1) cooperative measurement output from the performance of at least two or more cooperative measurement techniques and/or (2) measurement output from the performance of legacy measurement(s) at UE 1004-1 (both referred to herein as “measurement output”). For example, a first event condition may include a difference between first measurement output (e.g., based on performing a first cooperative measurement technique or legacy measurement(s)) and second measurement output (e.g., based on performing a second cooperative measurement technique) satisfying a first threshold. For example:

$$\vert First measurement ouput - Second measurement output \vert > First threshold$$

As another example, a second event condition may include a difference between an average of first measurement output (e.g., based on performing a first cooperative measurement technique and/or legacy measurement(s)) and second measurement output (e.g., based on performing a second cooperative measurement technique) satisfying a second threshold. For example:

$$\vert Avg ( First measurement output ) - Second measurement output \vert > Second threshold$$

As another example, a third event condition may include a difference between an average of first measurement output (e.g., based on performing a first cooperative measurement technique or legacy measurement(s)) and an average of second measurement output (e.g., based on performing a second cooperative measurement technique) satisfying a third threshold. For example:

$$\vert Avg ( First measurement output ) - Avg ( Second measurement output ) \vert > Third threshold$$

In certain aspects, UE 1004-1 may be configured to select the measurement techniques to use for the event condition comparisons, such as based on available measurement determination methods. That is, UE 1004-1 may obtain an indication of a plurality of available measurement determination methods (not shown in FIG. 10), which UE 1004-1 may select from.

In certain aspects, UE 1004-1 may be configured to indicate the measurement determination methods, selected to be used to determining whether one or more event conditions are satisfied, to network entity 1002. Thus, UE 1004 may be configured to send an indication of the selected measurement determination methods to network entity 1002 (not shown in FIG. 10).

The measurement generation and reporting configuration may be communicated via radio resource control (RRC) signaling, medium access control (MAC) signaling, downlink control information (DCI), and/or system information (SI).

In certain aspects, the measurement generation and reporting configuration may comprise a common configuration that is applicable to all cooperative measurement and legacy measurement techniques. For example, UE 1004-1 may be configured with a particular measurement resource for legacy measurement and/or cooperative measurement/prediction. If network entity 1002 wants to use this measurement resource for cooperative measurement and legacy measurement techniques in a common manner, a single common configuration may be present instead of repeatedly configuring UE 1004-1 with the ability to use this measurement resource for every cooperative measurement and legacy measurement technique.

After obtaining the measurement generation and reporting configuration, at 1012, UE 1004-1 identifies a group of UEs, including UE 1004-1, that may perform one or more cooperative measurement techniques. The group of UEs may include UEs that are associated with a co-location condition. For example, the group of UEs may include UEs that are close in proximity to one another, and thus experience similar channel conditions. In this example, the group of UEs may include UE 1004-1 and UEs 1004-2 through 1004-X.

At 1014, UE 1004-1 communicates with UEs 1004-2 through 1004-X to establish which cooperative measurement technique(s) may be performed by the group of UEs for measurement generation and reporting (e.g., based on the measurement generation and reporting configuration sent to UE 1004-1 at 1010), and/or to establish which UEs are cooperative UEs or delegate UEs.

As described herein, the measurement generation and reporting configuration may configure UE 1004-1 to report at least one measurement value, where the at least one measurement value is based on cooperative measurement output from UEs 1004 performing one or more cooperative measurement techniques. Thus, UEs 1004 may perform one or more cooperative measurement techniques, and the output from the performance of these cooperative measurement technique(s) (e.g., “cooperative measurement output”) may be obtained by UE 1004-1. For example, where UEs 1004 perform measurement delegation, the cooperative measurement output obtained, at 1016 by UE 1004-1, may include output from one or measurements performed by one or more of UEs 1004-2 through 1004-X (e.g., “delegate UE(s)”).

In certain aspects, the measurement generation and reporting configuration may configure UE 1004-1 to perform one or more legacy measurements. Thus, in certain aspects, at 1018, UE 1004-1 may perform actual measurement(s).

In certain aspects, the measurement generation and reporting configuration may configure UE 1004-1 to perform cooperative measurement techniques, including (1) measurement prediction based on measurement delegation, (2) measurement prediction based on measurement collaboration, and/or (3) measurement prediction collaboration. Thus, in certain aspects, at 1020, UE 1004-1 may generate one or more measurement predictions.

In certain aspects, the measurement generation and reporting configuration may configure UE 1004-1 to perform filtering, as described in detail above. Thus, in certain aspects, at 1022, UE 1004-1 may perform filtering, based on one or more filter coefficient thresholds, such as to remove a subset of measurement output data resulting from the performance of one or more cooperative measurement techniques and/or legacy measurement(s) at UE 1004-1.

In certain aspects, the measurement generation and reporting configuration may configure UE 1004-1 to perform measurement reporting, to network entity 1002, in accordance with one or more event conditions, as described in detail above. Thus, in certain aspects, at 1024, UE 1004-1 may determine if one or more event conditions are satisfied. If the one or more event conditions are satisfied, then process flow 100 may proceed with steps 1026 and 1028.

Specifically, at 1026, UE 1004-1 determines at least one measurement value to report to network entity 1002. As described above, in certain aspects, UE 1004-1 may determine, at 1026, multiple measurement values (e.g., such as based on the measurement generation and reporting configuration sent to UE 1004-1 at 1010). In certain other aspects, UE 1004-1 may determine, at 1026, a single measurement value (e.g., such as based on the measurement generation and reporting configuration sent to UE 1004-1 at 1010).

At 1028, UE sends, to network entity 1002, a measurement report including the at least one measurement value. In certain aspects, network entity 1002 may use this at least one measurement value to generate a UE mobility decision for UE 1004-1. For example, at 1030, network entity 1002 may determine whether handover for UE 1004-1 should be triggered. In certain aspects, the UE mobility decision may include information such as a handover target, a communication failure event justifying the handover, and/or a measurement event justifying the handover, such as when network entity 1002 determines that UE 1004-1 should be handed over to another network entity.

In certain aspects where the measurement report comprises an L1 report including at least one L1 measurement, the measurement report may be sent to network entity 1002, from UE 1004-1 at 1028, via uplink control information (UCI). In certain aspects where the measurement report comprises an L1 report including at least one L1 measurement, the measurement report may be sent to network entity 1002, from UE 1004-1 at 1028, via a MAC-CE. In certain aspects, where the measurement report comprises an L3 report include at least one L3 measurement, the measure report may be sent to network entity 1002, from UE 1004-1 at 1028, via RRC signaling.

In certain aspects where the measurement report comprises an L1 report including at least one L1 measurement, UE 1004-1 may send the measurement report to network entity 10012 at 1028, such as based on an explicit timeline. For example, the timeline may be defined with respect to measurement resource, measurement processing, measurement prediction processing, local signaling among UEs (e.g., in cases where local collaboration is enabled), and/or the like.

In certain aspects where the measurement report comprises an L3 report including at least one L3 measurement, UE 1004-1 may send the measurement report to network entity 10012 at 1028 at any arbitrary time (e.g., no timeline may be defined). For example, once UE 1004-1 has generated the measurement report, the transmission of the measurement report may be treated as a regular physical uplink shared channel (PUSCH) transmission.

Note that the process flow 1000 illustrated in FIG. 10 is described herein to facilitate an understanding of measurement generation and reporting, and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### Example Operations of a UE

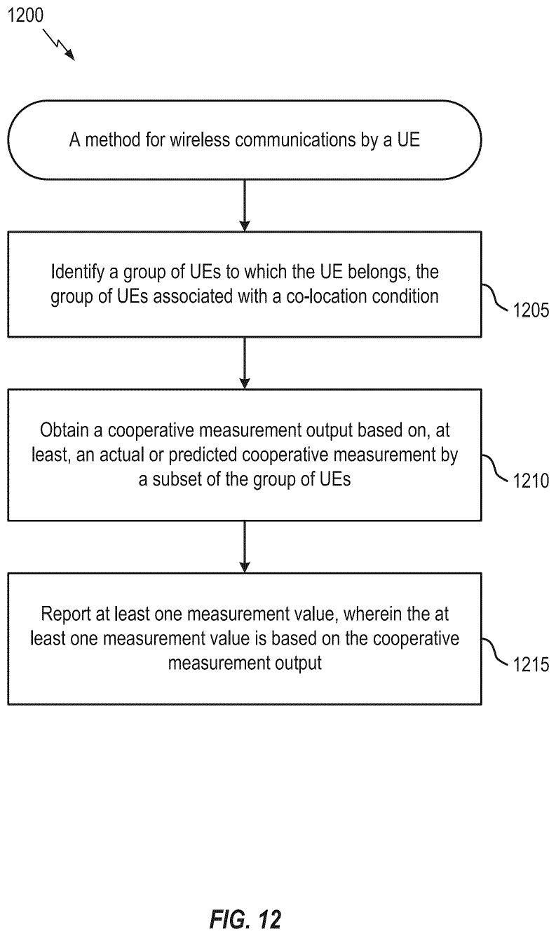

FIG. 12 shows a method 1200 for wireless communications by an apparatus, such as UE 104 of FIG. 1 or UE 304 of FIG. 3.

Method 1200 begins at block 1205 with identifying a group of UEs to which the UE belongs, the group of UEs associated with a co-location condition.

Method 1200 then proceeds to block 1210 with obtaining a cooperative measurement output based on, at least, an actual or predicted cooperative measurement by a subset of the group of UEs.

Method 1200 then proceeds to block 1215 with reporting at least one measurement value, wherein the at least one measurement value is based on the cooperative measurement output.

In some aspects, the actual or predicted cooperative measurement comprises one or more of: one or more first measurements by one or more delegate UEs of the group of UEs; a plurality of second measurements by one or more collaborative UEs of the group of UEs and the UE; the one or more first measurements and a first measurement prediction, by the UE, based on the one or more first measurements; the plurality of second measurements and a second measurement prediction, by the UE, based on the plurality of second measurements; one or more third measurement predictions by the one or more delegate UEs of the group of UEs; or one or more fourth measurement predictions by the one or more collaborative UEs of the group of UEs and the UE.

In some aspects, the cooperative measurement output comprises two or more of: first output from the one or more first measurements; second output from the plurality of second measurements; third output from one or more third measurements by the UE; fourth output from the one or more first measurements and the first measurement prediction; fifth output from the plurality of second measurements and the second measurement prediction; sixth output from the one or more third measurement predictions; or seventh output from the one or more fourth measurement predictions.

In some aspects, the cooperative measurement output comprises the third output from the one or more third measurements by the UE; and the method 1200 further comprises performing the one or more third measurements.

In some aspects, at least one of the fourth output, the fifth output, the sixth output, or the seventh output comprises: a temporal domain prediction; a spatial domain prediction; or a spatiotemporal domain prediction.

In some aspects, method 1200 further includes obtaining signaling that configures the UE to: determine a single measurement value based on the cooperative measurement output; and report the single measurement value as the at least one measurement value.

In some aspects, method 1200 further includes reporting the at least one measurement value comprises reporting the single measurement value based on the signaling.

In some aspects, method 1200 further includes at least based on the signaling, determining the single measurement value based on each output of the cooperative measurement output and a respective weight associated with each output.

In some aspects, method 1200 further includes before determining the single measurement value, applying a filter to each output of one or more outputs of the cooperative measurement output to smooth each output based on one or more filter coefficients.

In some aspects, method 1200 further includes obtaining an indication of the respective weight associated with each output of the cooperative measurement output.

In some aspects, method 1200 further includes determining the respective weight associated with each output of the cooperative measurement output.

In some aspects, method 1200 further includes at least based on the signaling, determining the single measurement value based on each output of the cooperative measurement output and a respective contribution percentage associated with each output.

In some aspects, method 1200 further includes determining the respective contribution percentage associated with each output, of the cooperative measurement output, based on an accuracy threshold.

In some aspects, method 1200 further includes obtaining an indication of the accuracy threshold.

In some aspects, block 1215 includes reporting the at least one measurement value in accordance with one or more event conditions.

In some aspects, the one or more event conditions comprise one or more of: a first event condition where a first difference between a first event condition output of the cooperative measurement output and a second event condition output of the cooperative measurement output satisfies a first threshold; a second event condition where a second difference between an average of the first event condition output and the second event condition output satisfies a second threshold; a third event condition where a third difference between the average of the first event condition output and an average of the second event condition output satisfies a third threshold; or a fourth event condition where at least one output of the cooperative measurement output satisfies a fourth threshold.

In some aspects, block 1215 includes: based on the one or more event conditions, reporting at least one of: the first difference; the second difference; the third difference; the average of the first event condition output; the average of the second event condition output; or the at least one output of the cooperative measurement output.

In some aspects, method 1200 further includes obtaining an indication of a plurality of available measurement determination methods, wherein the available measurement determination methods comprise: the actual or predicted cooperative measurement; or the actual or predicted cooperative measurement and the one or more third measurements by the UE.

In some aspects, method 1200 further includes selecting a first measurement determination method and a second measurement determination method from the plurality of available measurement determination methods, wherein the first event condition output is based on the selected first measurement determination method and the second event condition is based on the selected second measurement determination method.

In some aspects, method 1200 further includes sending an indication of the first measurement determination method and the second measurement determination method selected by the UE.

In some aspects, the cooperative measurement output comprises multiple outputs; the method 1200 further comprises obtaining signaling that configures the UE to report, as a plurality of measurement values, each output of the multiple outputs of the cooperative measurement output; and block 1215 includes reporting the plurality of measurement values based on the signaling.

In some aspects, method 1200 further includes before reporting each output of the cooperative measurement output as the plurality of measurement values, applying a filter to each output of one or more outputs of the cooperative measurement output to smooth each output based on one or more filter coefficients.

In some aspects, the one or more filter coefficients comprise at least one of: a first filter coefficient associated with a first measurement output type, wherein the first measurement output type comprises actual measurement outputs from actual measurements by the UE; a second filter coefficient associated with a second measurement output type, wherein the second measurement output type comprises actual measurement outputs from actual measurements by one or more other UEs of the group of UEs; or a third filter coefficient associated with a third measurement output type, wherein the third measurement output type comprises predicted measurement outputs from measurement predictions by the group of UEs.

In some aspects, method 1200 further includes obtaining an indication of at least one of the first filter coefficient, the second filter coefficient, or the third filter coefficient.

In some aspects, method 1200 further includes obtaining an indication of at least one of: a first set of filter coefficients associated with the first measurement output type; a second set of filter coefficients associated with the second measurement output type; or a third set of filter coefficients associated with the third measurement output type.

In some aspects, method 1200 further includes obtaining an indication of at least one of: a first set of filter coefficient thresholds associated with the first measurement output type; a second set of filter coefficient thresholds associated with the second measurement output type; or a third set of filter coefficient thresholds associated with the third measurement output type, wherein selecting at least one of the first filter coefficient, the second filter coefficient, or the third filter coefficient comprises selecting at least one of: the first filter coefficient from the first set of filter coefficients; the second filter coefficient from the second set of filter coefficients; or the third filter coefficient from the third set of filter coefficients.

In some aspects, method 1200 further includes selecting at least one of the first filter coefficient, the second filter coefficient, or the third filter coefficient.

In some aspects, each measurement value of the plurality of measurement values is associated with a respective output of the cooperative measurement output; and reporting the plurality of measurement values comprises reporting the plurality of measurement values and an indication of the respective output associated with each of the plurality of measurement values.

In some aspects, the at least one measurement value comprises a RRM measurement value.

In some aspects, the at least one measurement value comprises a L1 measurement value.

In some aspects, block 1215 includes reporting the L1 measurement value via UCI.

In some aspects, block 1215 includes reporting the L1 measurement value via a MAC-CE.

In some aspects, the at least one measurement value comprises a L3 measurement value.

In some aspects, block 1215 includes reporting the L3 measurement value via RRC signaling.

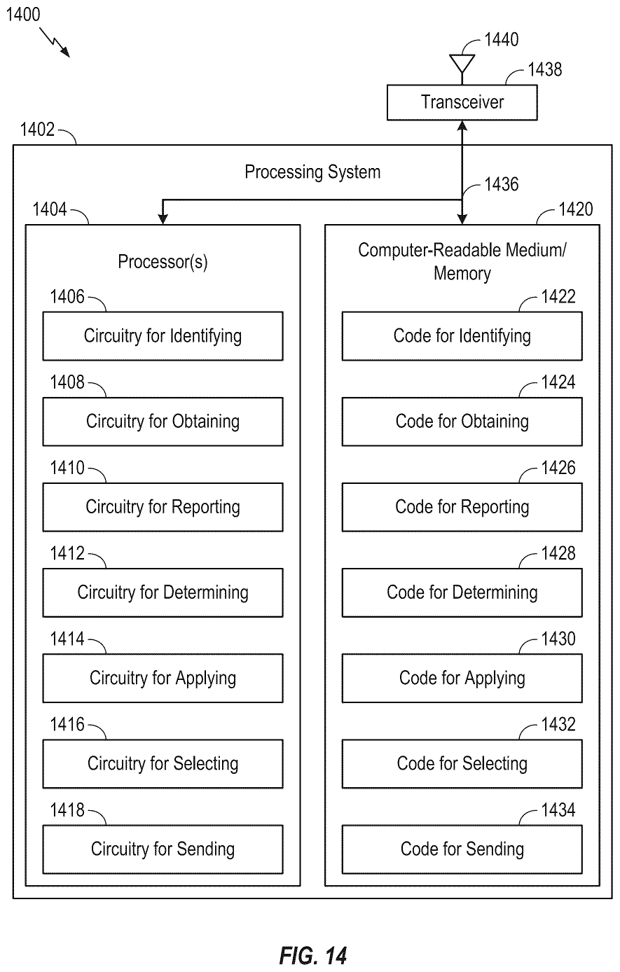

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Operations of a Network Entity

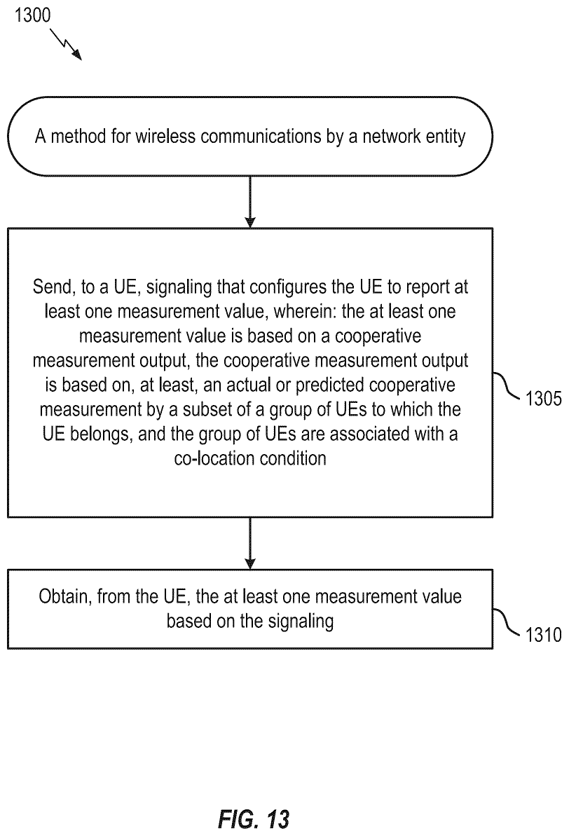

FIG. 13 shows a method 1300 for wireless communications by an apparatus, such as BS 102 of FIG. 1, a first network entity 300 or second network entity 302 of FIG. 3, or a disaggregated base station as discussed with respect to FIG. 2.

Method 1300 begins at block 1305 with sending, to a UE, signaling that configures the UE to report at least one measurement value, wherein: the at least one measurement value is based on a cooperative measurement output, the cooperative measurement output is based on, at least, an actual or predicted cooperative measurement by a subset of a group of UEs to which the UE belongs, and the group of UEs are associated with a co-location condition.

Method 1300 then proceeds to block 1310 with obtaining, from the UE, the at least one measurement value based on the signaling.

In some aspects, the actual or predicted cooperative measurement comprises one or more of: one or more first measurements by one or more delegate UEs of the group of UEs; a plurality of second measurements by one or more collaborative UEs of the group of UEs and the UE; the one or more first measurements and a first measurement prediction, by the UE, based on the one or more first measurements; the plurality of second measurements and a second measurement prediction, by the UE, based on the plurality of second measurements; one or more third measurement predictions by the one or more delegate UEs of the group of UEs; or one or more fourth measurement predictions by the one or more collaborative UEs of the group of UEs and the UE.

In some aspects, the cooperative measurement output comprises two or more of: first output from the one or more first measurements; second output from the plurality of second measurements; third output from one or more third measurements by the UE; fourth output from the one or more first measurements and the first measurement prediction; fifth output from the plurality of second measurements and the second measurement prediction; sixth output from the one or more third measurement predictions; or seventh output from the one or more fourth measurement predictions.

In some aspects, at least one of the fourth output, the fifth output, the sixth output, or the seventh output comprises: a temporal domain prediction; a spatial domain prediction; or a spatiotemporal domain prediction.

In certain aspects, method 1300 further includes sending signaling that configures the UE to: determine a single measurement value based on the cooperative measurement output; and report the single measurement value as the at least one measurement value.

In certain aspects, method 1300 further includes obtaining the at least one measurement value comprises obtaining the single measurement value based on the signaling.

In some aspects, sending signaling that configures the UE to determine the single measurement value based on the cooperative measurement output comprises sending signaling that configures the UE to determine the single measurement value based on each output of the cooperative measurement output and a respective weight associated with each output.

In certain aspects, method 1300 further includes sending an indication of the respective weight associated with each output of the cooperative measurement output.

In some aspects, sending signaling that configures the UE to determine the single measurement value based on the cooperative measurement output comprises sending signaling that configures the UE to determine the single measurement value based on each output of the cooperative measurement output and a respective contribution percentage associated with each output.

In certain aspects, method 1300 further includes sending an indication of the respective contribution percentage associated with each output of the cooperative measurement output.

In some aspects, the respective contribution percentage associated with each output, of the cooperative measurement output, is based on an accuracy threshold; and the method 1300 further comprises sending an indication of the accuracy threshold.

In some aspects, block 1310 includes obtaining the at least one measurement value based on a satisfaction of one or more event conditions.

In some aspects, the one or more event conditions comprise one or more of: a first event condition where a first difference between a first event condition output of the cooperative measurement output and a second event condition output of the cooperative measurement output satisfies a first threshold; a second event condition where a second difference between an average of the first event condition output and the second event condition output satisfies a second threshold; a third event condition where a third difference between the average of the first event condition output and an average of the second event condition output satisfies a third threshold; or a fourth event condition where at least one output of the cooperative measurement output satisfies a fourth threshold.

In some aspects, block 1310 includes: based on the satisfaction of the one or more event conditions, obtaining at least one of: the first difference; the second difference; the third difference; the average of the first event condition output; the average of the second event condition output; or the at least one output of the cooperative measurement output.

In certain aspects, method 1300 further includes sending an indication of a plurality of available measurement determination methods; the available measurement determination methods comprise: the actual or predicted cooperative measurement; or the actual or predicted cooperative measurement and the one or more third measurements by the UE; the first event condition output is based on a first measurement determination method of the plurality of available measurement determination methods; and the second event condition output is based on a second measurement determination method of the plurality of available measurement determination methods.

In certain aspects, method 1300 further includes obtaining an indication of the first measurement determination method and the second measurement determination method.

In some aspects, the cooperative measurement output comprises multiple outputs; the method 1300 further comprises sending signaling that configures the UE to report, as a plurality of measurement values, each output of the multiple outputs of the cooperative measurement output; and block 1310 includes obtaining the plurality of measurement values based on the signaling.

In certain aspects, method 1300 further includes sending an indication of at least one of: a first filter coefficient associated with a first measurement output type, wherein the first measurement output type comprises actual measurement outputs from actual measurements by the UE; a second filter coefficient associated with a second measurement output type, wherein the second measurement output type comprises actual measurement outputs from actual measurements by one or more other UEs, other than the UE, of the group of UEs; or a third filter coefficient associated with a third measurement output type, wherein the third measurement output type comprises predicted measurement outputs from measurement predictions by the group of UEs.

In certain aspects, method 1300 further includes sending an indication of at least one of: a first set of filter coefficients associated with a first measurement output type, wherein the first measurement output type comprises actual measurement outputs from actual measurements by the UE; a second set of filter coefficients associated with a second measurement output type, wherein the second measurement output type comprises actual measurement outputs from actual measurements by one or more other UEs, other than the UE, of the group of UEs; or a third set of filter coefficients associated with a third measurement output type, wherein the third measurement output type comprises predicted measurement outputs from measurement predictions by the group of UEs.

In some aspects, each measurement value of the plurality of measurement values is associated with a respective output of the cooperative measurement output; and obtaining the plurality of measurement values comprises obtaining the plurality of measurement values and an indication of the respective output associated with each of the plurality of measurement values.

In some aspects, the at least one measurement value comprises a RRM measurement value.

In some aspects, the at least one measurement value comprises a L1 measurement value.

In some aspects, block 1310 includes obtaining the L1 measurement value via UCI.

In some aspects, block 1310 includes obtaining the L1 measurement value via a MAC-CE.

In some aspects, the at least one measurement value comprises a L3 measurement value.

In some aspects, block 1310 includes obtaining the L3 measurement value via RRC signaling.

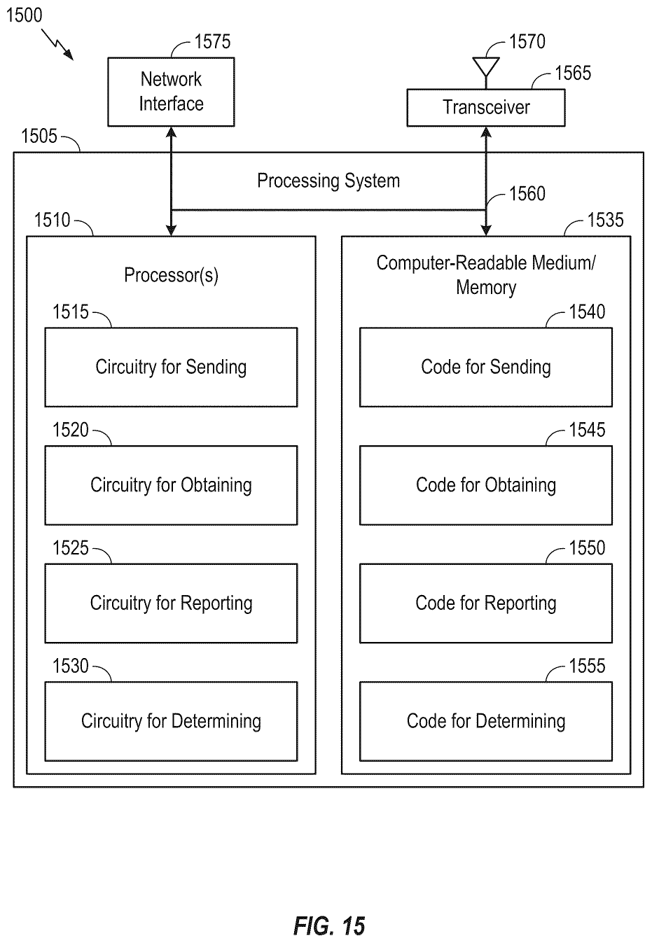

In some aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure.

### Example Communications Devices

FIG. 14 depicts aspects of an example communications device 1400 configured for wireless communications. In some aspects, communications device 1400 is a user equipment, such as UE 104 described above with respect to FIG. 1 or UE 304 described with respect to FIG. 3.

The communications device 1400 includes a processing system 1402 coupled to a transceiver 1438 (e.g., a transmitter and/or a receiver). The transceiver 1438 is configured to transmit and receive signals for the communications device 1400 via an antenna 1440, such as the various signals as described herein. The processing system 1402 may be configured to perform processing functions for the communications device 1400, including processing signals received and/or to be transmitted by the communications device 1400.

The processing system 1402 includes one or more processors 1404 and a computer-readable medium/memory 1420. In various aspects, the one or more processors 1404 may be representative of the one or more processors 318 described with respect to FIG. 3. The one or more processors 1404 are coupled to a computer-readable medium/memory 1420 via a bus 1436. In some aspects, the computer-readable medium/memory 1420 may be representative of the one or more memories 320 described with respect to FIG. 3. The computer-readable medium/memory 1420 is a non-transitory computer-readable medium/memory. In certain aspects, the computer-readable medium/memory 1420 is configured to store instructions (e.g., computer-executable code), that when executed by the one or more processors 1404, cause the one or more processors 1404 to perform the method 1200 described with respect to FIG. 12, or any aspect related to it, including any operations described in relation to FIG. 12. Note that reference to a processor performing a function of communications device 1400 may include one or more processors performing that function of communications device 1400, such as in a distributed fashion.

In the depicted example, computer-readable medium/memory 1420 stores code (e.g., executable instructions), including code for identifying 1422, code for obtaining 1424, code for reporting 1426, code for determining 1428, code for applying 1430, code for selecting 1432, and code for sending 1434. Processing of the code 1422-1434 may enable and cause the communications device 1400 to perform the method 1200 described with respect to FIG. 12, or any aspect related to it. For instance, in some aspects, code for identifying 1422 includes code for identifying a group of UEs to which the UE belongs, the group of UEs associated with a co-location condition. In some aspects, code for obtaining 1424 includes code for obtaining a cooperative measurement output based on, at least, an actual or predicted cooperative measurement by a subset of the group of UEs. In some aspects, code for reporting 1426 includes code for reporting at least one measurement value, wherein the at least one measurement value is based on the cooperative measurement output.

The one or more processors 1404 include circuitry configured to implement (e.g., execute) the code stored in the computer-readable medium/memory 1420, including circuitry for identifying 1406, circuitry for obtaining 1408, circuitry for reporting 1410, circuitry for determining 1412, circuitry for applying 1414, circuitry for selecting 1416, and circuitry for sending 1418. Processing with circuitry 1406-1418 may enable and cause the communications device 1400 to perform the method 1200 described with respect to FIG. 12, or any aspect related to it. For instance, in some aspects, circuitry for identifying 1406 includes circuitry for identifying a group of UEs to which the UE belongs, the group of UEs associated with a co-location condition. In some aspects, circuitry for obtaining 1408 includes circuitry for obtaining a cooperative measurement output based on, at least, an actual or predicted cooperative measurement by a subset of the group of UEs. In some aspects, circuitry for reporting 1410 includes circuitry for reporting at least one measurement value, wherein the at least one measurement value is based on the cooperative measurement output.

More generally, means for communicating, transmitting, sending or outputting for transmission may include the one or more transceivers 324, one or more antenna 322 and/or processing system 316 of the UE 304 illustrated in FIG. 3, transceiver 1438 and/or antenna 1440 of the communications device 1400 in FIG. 14, and/or one or more processors 1404 of the communications device 1400 in FIG. 14. Means for communicating, receiving or obtaining may include the one or more transceivers 324, one or more antennas 322, and/or processing system 316 of the UE 304 illustrated in FIG. 3, transceiver 1438 and/or antenna 1440 of the communications device 1400 in FIG. 14, and/or one or more processors 1404 of the communications device 1400 in FIG. 14.

FIG. 15 depicts aspects of an example communications device configured for wireless communications. In some aspects, communications device 1500 is a network entity, such as BS 102 of FIG. 1, first network entity 300 or second network entity 302 of FIG. 3, or a disaggregated base station as discussed with respect to FIG. 2.

The communications device 1500 includes a processing system 1505 coupled to a transceiver 1565 (e.g., a transmitter and/or a receiver) and/or a network interface 1575. The transceiver 1565 is configured to transmit and receive signals for the communications device 1500 via an antenna 1570, such as the various signals as described herein. The network interface 1575 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510 and a computer-readable medium/memory 1535. In various aspects, one or more processors 1510 may be representative of the one or more processors 308, as described with respect to FIG. 3. The one or more processors 1510 are coupled to the computer-readable medium/memory 1535 via a bus 1560. In certain aspects, the computer-readable medium/memory 1535 is configured to store instructions (e.g., computer-executable code), including code 1540-1555, that when executed by the one or more processors 1510, cause the one or more processors 1510 to perform the method 1300 described with respect to FIG. 13, or any aspect related to it, including any operations described in relation to FIG. 13. The computer-readable medium/memory 1535 is a non-transitory computer-readable medium/memory. Note that reference to a processor of communications device 1500 performing a function may include one or more processors of communications device 1500 performing that function, such as in a distributed fashion.

In the depicted example, the computer-readable medium/memory 1535 stores code (e.g., executable instructions), including code for sending 1540, code for obtaining 1545, code for reporting 1550, and code for determining 1555. Processing of the code 1540-1555 may enable and cause the communications device 1500 to perform the method 1300 described with respect to FIG. 13, or any aspect related to it. For instance, in some aspects, code for sending 1540 includes code for sending, to a UE, signaling that configures the UE to report at least one measurement value, wherein: the at least one measurement value is based on a cooperative measurement output, the cooperative measurement output is based on, at least, an actual or predicted cooperative measurement by a subset of a group of UEs to which the UE belongs, and the group of UEs are associated with a co-location condition. In some aspects, code for obtaining 1545 includes code for obtaining, from the UE, the at least one measurement value based on the signaling.

The one or more processors 1510 include circuitry configured to implement (e.g., execute) the code stored in the computer-readable medium/memory 1535, including circuitry for sending 1515, circuitry for obtaining 1520, circuitry for reporting 1525, and circuitry for determining 1530. Processing with circuitry 1515-1530 may enable and cause the communications device 1500 to perform the method 1300 described with respect to FIG. 13, or any aspect related to it. For instance, in some aspects, circuitry for sending 1515 includes circuitry for sending, to a UE, signaling that configures the UE to report at least one measurement value, wherein: the at least one measurement value is based on a cooperative measurement output, the cooperative measurement output is based on, at least, an actual or predicted cooperative measurement by a subset of a group of UEs to which the UE belongs, and the group of UEs are associated with a co-location condition. In some aspects, circuitry for obtaining 1520 includes circuitry for obtaining, from the UE, the at least one measurement value based on the signaling.

Various components of the communications device 1500 may provide means for performing the method 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1565, antenna 1570, and/or network interface 1575 of the communications device 1500 in FIG. 15, and/or one or more processors 1510 of the communications device 1500 in FIG. 15. Means for communicating, receiving or obtaining may include the one or more transceivers 312, one or more antennas 314, and/or processing system 306 of the first network entity 300 or the second network entity 302 illustrated in FIG. 3, transceiver 1565, antenna 1570, and/or network interface 1575 of the communications device 1500 in FIG. 15, and/or one or more processors 1510 of the communications device 1500 in FIG. 15.

### Example Clauses

Implementation examples are described in the following numbered clauses:

Clause 1: A method for wireless communications by a UE comprising: identifying a group of UEs to which the UE belongs, the group of UEs associated with a co-location condition; obtaining a cooperative measurement output based on, at least, an actual or predicted cooperative measurement by a subset of the group of UEs; and reporting at least one measurement value, wherein the at least one measurement value is based on the cooperative measurement output.

Clause 2: The method of Clause 1, wherein the actual or predicted cooperative measurement comprises one or more of: one or more first measurements by one or more delegate UEs of the group of UEs; a plurality of second measurements by one or more collaborative UEs of the group of UEs and the UE; the one or more first measurements and a first measurement prediction, by the UE, based on the one or more first measurements; the plurality of second measurements and a second measurement prediction, by the UE, based on the plurality of second measurements; one or more third measurement predictions by the one or more delegate UEs of the group of UEs; or one or more fourth measurement predictions by the one or more collaborative UEs of the group of UEs and the UE.

Clause 3: The method of Clause 2, wherein the cooperative measurement output comprises two or more of: first output from the one or more first measurements; second output from the plurality of second measurements; third output from one or more third measurements by the UE; fourth output from the one or more first measurements and the first measurement prediction; fifth output from the plurality of second measurements and the second measurement prediction; sixth output from the one or more third measurement predictions; or seventh output from the one or more fourth measurement predictions.

Clause 4: The method of Clause 3, wherein: the cooperative measurement output comprises the third output from the one or more third measurements by the UE; and the method further comprises performing the one or more third measurements.

Clause 5: The method of Clause 3, wherein at least one of the fourth output, the fifth output, the sixth output, or the seventh output comprises: a temporal domain prediction; a spatial domain prediction; or a spatiotemporal domain prediction.

Clause 6: The method of any one of Clauses 1-5, wherein: the cooperative measurement output comprises multiple outputs; the method further comprises obtaining signaling that configures the UE to report, as a plurality of measurement values, each output of the multiple outputs of the cooperative measurement output; and reporting the at least one measurement value comprises reporting the plurality of measurement values based on the signaling.

Clause 7: The method of Clause 6, further comprising: before reporting each output of the cooperative measurement output as the plurality of measurement values, applying a filter to each output of one or more outputs of the cooperative measurement output to smooth each output based on one or more filter coefficients.

Clause 8: The method of Clause 7, wherein the one or more filter coefficients comprise at least one of: a first filter coefficient associated with a first measurement output type, wherein the first measurement output type comprises actual measurement outputs from actual measurements by the UE; a second filter coefficient associated with a second measurement output type, wherein the second measurement output type comprises actual measurement outputs from actual measurements by one or more other UEs of the group of UEs; or a third filter coefficient associated with a third measurement output type, wherein the third measurement output type comprises predicted measurement outputs from measurement predictions by the group of UEs.

Clause 9: The method of Clause 8, further comprising obtaining an indication of at least one of the first filter coefficient, the second filter coefficient, or the third filter coefficient.

Clause 10: The method of Clause 8, further comprising selecting at least one of the first filter coefficient, the second filter coefficient, or the third filter coefficient.

Clause 11: The method of Clause 10, further comprising obtaining an indication of at least one of: a first set of filter coefficient thresholds associated with the first measurement output type; a second set of filter coefficient thresholds associated with the second measurement output type; or a third set of filter coefficient thresholds associated with the third measurement output type, wherein selecting at least one of the first filter coefficient, the second filter coefficient, or the third filter coefficient comprises selecting at least one of: the first filter coefficient from the first set of filter coefficients; the second filter coefficient from the second set of filter coefficients; or the third filter coefficient from the third set of filter coefficients.

Clause 12: The method of Clause 6, wherein: each measurement value of the plurality of measurement values is associated with a respective output of the cooperative measurement output; and reporting the plurality of measurement values comprises reporting the plurality of measurement values and an indication of the respective output associated with each of the plurality of measurement values.

Clause 13: The method of Clause 3, further comprising obtaining signaling that configures the UE to: determine a single measurement value based on the cooperative measurement output; and report the single measurement value as the at least one measurement value; and reporting the at least one measurement value comprises reporting the single measurement value based on the signaling.

Clause 14: The method of Clause 13, further comprising at least based on the signaling, determining the single measurement value based on each output of the cooperative measurement output and a respective weight associated with each output.

Clause 15: The method of Clause 14, further comprising: before determining the single measurement value, applying a filter to each output of one or more outputs of the cooperative measurement output to smooth each output based on one or more filter coefficients.

Clause 16: The method of Clause 14, further comprising obtaining an indication of the respective weight associated with each output of the cooperative measurement output.

Clause 17: The method of Clause 14, further comprising determining the respective weight associated with each output of the cooperative measurement output.

Clause 18: The method of Clause 13, further comprising at least based on the signaling, determining the single measurement value based on each output of the cooperative measurement output and a respective contribution percentage associated with each output.

Clause 19: The method of Clause 18, further comprising: before the UE determines the single measurement value, apply a filter to each output of one or more outputs of the cooperative measurement output to smooth each output based on one or more filter coefficients.

Clause 20: The method of Clause 18, further comprising obtaining an indication of the respective contribution percentage associated with each output of the cooperative measurement output.

Clause 21: The method of Clause 18, further comprising determining the respective contribution percentage associated with each output of the cooperative measurement output.

Clause 22: The method of Clause 18, further comprising determining the respective contribution percentage associated with each output, of the cooperative measurement output, based on an accuracy threshold.

Clause 23: The method of Clause 22, further comprising obtaining an indication of the accuracy threshold.

Clause 24: The method of Clause 3, wherein reporting the at least one measurement value comprises reporting the at least one measurement value in accordance with one or more event conditions.

Clause 25: The method of Clause 24, wherein the one or more event conditions comprise one or more of: a first event condition where a first difference between a first event condition output of the cooperative measurement output and a second event condition output of the cooperative measurement output satisfies a first threshold; a second event condition where a second difference between an average of the first event condition output and the second event condition output satisfies a second threshold; a third event condition where a third difference between the average of the first event condition output and an average of the second event condition output satisfies a third threshold; or a fourth event condition where at least one output of the cooperative measurement output satisfies a fourth threshold.

Clause 26: The method of Clause 25, wherein reporting the at least one measurement value comprises: based on the one or more event conditions, reporting at least one of: the first difference; the second difference; the third difference; the average of the first event condition output; the average of the second event condition output; or the at least one output of the cooperative measurement output.

Clause 27: The method of Clause 25, further comprising: obtaining an indication of a plurality of available measurement determination methods, wherein the available measurement determination methods comprise: the actual or predicted cooperative measurement; or the actual or predicted cooperative measurement and the one or more third measurements by the UE; and selecting a first measurement determination method and a second measurement determination method from the plurality of available measurement determination methods, wherein the first event condition output is based on the selected first measurement determination method and the second event condition is based on the selected second measurement determination method.

Clause 28: The method of Clause 27, further comprising sending an indication of the first measurement determination method and the second measurement determination method selected by the UE.

Clause 29: The method of any one of Clauses 1-28, wherein the at least one measurement value comprises a RRM measurement value.

Clause 30: The method of any one of Clauses 1-29, wherein the at least one measurement value comprises a L1 measurement value.

Clause 31: The method of Clause 30, wherein reporting the at least one measurement value comprises reporting the L1 measurement value via UCI.

Clause 32: The method of Clause 30, wherein reporting the at least one measurement value comprises reporting the L1 measurement value via a MAC-CE.

Clause 33: The method of any one of Clauses 1-32, wherein the at least one measurement value comprises a L3 measurement value.

Clause 34: The method of Clause 33, wherein reporting the at least one measurement value comprises reporting the L3 measurement value via RRC signaling.

Clause 35: A method for wireless communications by a network entity comprising: sending, to a UE, signaling that configures the UE to report at least one measurement value, wherein: the at least one measurement value is based on a cooperative measurement output, the cooperative measurement output is based on, at least, an actual or predicted cooperative measurement by a subset of a group of UEs to which the UE belongs, and the group of UEs are associated with a co-location condition; and obtaining, from the UE, the at least one measurement value based on the signaling.

Clause 36: The method of Clause 35, wherein the actual or predicted cooperative measurement comprises one or more of: one or more first measurements by one or more delegate UEs of the group of UEs; a plurality of second measurements by one or more collaborative UEs of the group of UEs and the UE; the one or more first measurements and a first measurement prediction, by the UE, based on the one or more first measurements; the plurality of second measurements and a second measurement prediction, by the UE, based on the plurality of second measurements; one or more third measurement predictions by the one or more delegate UEs of the group of UEs; or one or more fourth measurement predictions by the one or more collaborative UEs of the group of UEs and the UE.

Clause 37: The method of Clause 36, wherein the cooperative measurement output comprises two or more of: first output from the one or more first measurements; second output from the plurality of second measurements; third output from one or more third measurements by the UE; fourth output from the one or more first measurements and the first measurement prediction; fifth output from the plurality of second measurements and the second measurement prediction; sixth output from the one or more third measurement predictions; or seventh output from the one or more fourth measurement predictions.

Clause 38: The method of Clause 37, wherein at least one of the fourth output, the fifth output, the sixth output, or the seventh output comprises: a temporal domain prediction; a spatial domain prediction; or a spatiotemporal domain prediction.

Clause 39: The method of any one of Clauses 35-38, wherein: the cooperative measurement output comprises multiple outputs; the method further comprises sending signaling that configures the UE to report, as a plurality of measurement values, each output of the multiple outputs of the cooperative measurement output; and obtaining the at least one measurement value comprises obtaining the plurality of measurement values based on the signaling.

Clause 40: The method of Clause 39, further comprising sending an indication of at least one of: a first filter coefficient associated with a first measurement output type, wherein the first measurement output type comprises actual measurement outputs from actual measurements by the UE; a second filter coefficient associated with a second measurement output type, wherein the second measurement output type comprises actual measurement outputs from actual measurements by one or more other UEs, other than the UE, of the group of UEs; or a third filter coefficient associated with a third measurement output type, wherein the third measurement output type comprises predicted measurement outputs from measurement predictions by the group of UEs.

Clause 41: The method of Clause 39, further comprising sending an indication of at least one of: a first set of filter coefficients associated with a first measurement output type, wherein the first measurement output type comprises actual measurement outputs from actual measurements by the UE; a second set of filter coefficients associated with a second measurement output type, wherein the second measurement output type comprises actual measurement outputs from actual measurements by one or more other UEs, other than the UE, of the group of UEs; or a third set of filter coefficients associated with a third measurement output type, wherein the third measurement output type comprises predicted measurement outputs from measurement predictions by the group of UEs.

Clause 42: The method of Clause 39, wherein: each measurement value of the plurality of measurement values is associated with a respective output of the cooperative measurement output; and obtaining the plurality of measurement values comprises obtaining the plurality of measurement values and an indication of the respective output associated with each of the plurality of measurement values.

Clause 43: The method of Clause 37, further comprising sending signaling that configures the UE to: determine a single measurement value based on the cooperative measurement output; and report the single measurement value as the at least one measurement value; and obtaining the at least one measurement value comprises obtaining the single measurement value based on the signaling.

Clause 44: The method of Clause 43, wherein sending signaling that configures the UE to determine the single measurement value based on the cooperative measurement output comprises sending signaling that configures the UE to determine the single measurement value based on each output of the cooperative measurement output and a respective weight associated with each output.

Clause 45: The method of Clause 44, further comprising sending an indication of the respective weight associated with each output of the cooperative measurement output.

Clause 46: The method of Clause 43, wherein sending signaling that configures the UE to determine the single measurement value based on the cooperative measurement output comprises sending signaling that configures the UE to determine the single measurement value based on each output of the cooperative measurement output and a respective contribution percentage associated with each output.

Clause 47: The method of Clause 46, further comprising sending an indication of the respective contribution percentage associated with each output of the cooperative measurement output.

Clause 48: The method of Clause 46, wherein: the respective contribution percentage associated with each output, of the cooperative measurement output, is based on an accuracy threshold; and the method further comprises sending an indication of the accuracy threshold.

Clause 49: The method of Clause 37, wherein obtaining the at least one measurement value comprises obtaining the at least one measurement value based on a satisfaction of one or more event conditions.

Clause 50: The method of Clause 49, wherein the one or more event conditions comprise one or more of: a first event condition where a first difference between a first event condition output of the cooperative measurement output and a second event condition output of the cooperative measurement output satisfies a first threshold; a second event condition where a second difference between an average of the first event condition output and the second event condition output satisfies a second threshold; a third event condition where a third difference between the average of the first event condition output and an average of the second event condition output satisfies a third threshold; or a fourth event condition where at least one output of the cooperative measurement output satisfies a fourth threshold.

Clause 51: The method of Clause 50, wherein obtaining the at least one measurement value comprises: based on the satisfaction of the one or more event conditions, obtaining at least one of: the first difference; the second difference; the third difference; the average of the first event condition output; the average of the second event condition output; or the at least one output of the cooperative measurement output.

Clause 52: The method of Clause 50, further comprising sending an indication of a plurality of available measurement determination methods; the available measurement determination methods comprise: the actual or predicted cooperative measurement; or the actual or predicted cooperative measurement and the one or more third measurements by the UE; the first event condition output is based on a first measurement determination method of the plurality of available measurement determination methods; and the second event condition output is based on a second measurement determination method of the plurality of available measurement determination methods.

Clause 53: The method of Clause 52, further comprising obtaining an indication of the first measurement determination method and the second measurement determination method.

Clause 54: The method of any one of Clauses 35-53, wherein the at least one measurement value comprises a RRM measurement value.

Clause 55: The method of any one of Clauses 35-54, wherein the at least one measurement value comprises a L1 measurement value.

Clause 56: The method of Clause 55, wherein obtaining the at least one measurement value comprises obtaining the L1 measurement value via UCI.

Clause 57: The method of Clause 55, wherein obtaining the at least one measurement value comprises obtaining the L1 measurement value via a MAC-CE.

Clause 58: The method of any one of Clauses 35-57, wherein the at least one measurement value comprises a L3 measurement value.

Clause 59: The method of Clause 58, wherein obtaining the at least one measurement value comprises obtaining the L3 measurement value via RRC signaling.

Clause 60: One or more apparatuses, comprising: one or more memories comprising executable instructions; and one or more processors configured to execute the executable instructions and cause the one or more apparatuses to perform a method in accordance with any one of Clauses 1-59.

Clause 61: One or more apparatuses configured for wireless communications, comprising: one or more memories; and one or more processors, coupled to the one or more memories, configured to cause the one or more apparatuses to perform a method in accordance with any one of Clauses 1-59.

Clause 62: One or more apparatuses configured for wireless communications, comprising: one or more memories; and one or more processors, coupled to the one or more memories, configured to perform a method in accordance with any one of Clauses 1-59.

Clause 63: One or more apparatuses, comprising means for performing a method in accordance with any one of Clauses 1-59.

Clause 64: One or more non-transitory computer-readable media comprising executable instructions that, when executed by one or more processors of one or more apparatuses, cause the one or more apparatuses to perform a method in accordance with any one of Clauses 1-59.

Clause 65: One or more computer program products embodied on one or more computer-readable storage media comprising code for performing a method in accordance with any one of Clauses 1-59.

Clause 66: One or more apparatuses configured for wireless communications, comprising: a processing system that includes one or more processors and one or more memories coupled with the one or more processors, the processing system configured to cause the one or more apparatuses to perform a method in accordance with any one of Clauses 1-59.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
identify a group of UEs to which the UE belongs, the group of UEs associated with a co-location condition;
obtain a cooperative measurement output based on, at least, an actual or predicted cooperative measurement by a subset of the group of UEs; and
report at least one measurement value, wherein the at least one measurement value is based on the cooperative measurement output.

2. The apparatus of claim 1, wherein the actual or predicted cooperative measurement comprises one or more of:
one or more first measurements by one or more delegate UEs of the group of UEs;
a plurality of second measurements by one or more collaborative UEs of the group of UEs and the UE;
the one or more first measurements and a first measurement prediction, by the UE, based on the one or more first measurements;
the plurality of second measurements and a second measurement prediction, by the UE, based on the plurality of second measurements;
one or more third measurement predictions by the one or more delegate UEs of the group of UEs; or
one or more fourth measurement predictions by the one or more collaborative UEs of the group of UEs and the UE.

3. The apparatus of claim 2, wherein the cooperative measurement output comprises two or more of:
first output from the one or more first measurements;
second output from the plurality of second measurements;
third output from one or more third measurements by the UE;
fourth output from the one or more first measurements and the first measurement prediction;
fifth output from the plurality of second measurements and the second measurement prediction;
sixth output from the one or more third measurement predictions; or
seventh output from the one or more fourth measurement predictions.

4. The apparatus of claim 3, wherein:
the cooperative measurement output comprises the third output from the one or more third measurements by the UE; and
the processing system is configured to cause the UE to perform the one or more third measurements.

5. The apparatus of claim 1, wherein:
the cooperative measurement output comprises multiple outputs;
the processing system is configured to cause the UE to obtain signaling that configures the UE to report, as a plurality of measurement values, each output of the multiple outputs of the cooperative measurement output; and
to cause the UE to report the at least one measurement value, the processing system is configured to cause the UE to, based on the signaling, report the plurality of measurement values.

6. The apparatus of claim 5, wherein the processing system is configured to cause the UE to:
before the UE reports each output of the cooperative measurement output as the plurality of measurement values, apply a filter to each output of one or more outputs of the cooperative measurement output to smooth each output based on one or more filter coefficients.

7. The apparatus of claim 6, wherein the one or more filter coefficients comprise at least one of:
a first filter coefficient associated with a first measurement output type, wherein the first measurement output type comprises actual measurement outputs from actual measurements by the UE;
a second filter coefficient associated with a second measurement output type, wherein the second measurement output type comprises actual measurement outputs from actual measurements by one or more other UEs of the group of UEs; or
a third filter coefficient associated with a third measurement output type, wherein the third measurement output type comprises predicted measurement outputs from measurement predictions by the group of UEs.

8. The apparatus of claim 7, wherein the processing system is configured to cause the UE to select at least one of the first filter coefficient, the second filter coefficient, or the third filter coefficient.

9. The apparatus of claim 8, wherein:
the processing system is configured to cause the UE to obtain an indication of at least one of:
a first set of filter coefficients associated with the first measurement output type;
a second set of filter coefficients associated with the second measurement output type; or
a third set of filter coefficients associated with the third measurement output type; and
to cause the UE to select at least one of the first filter coefficient, the second filter coefficient, or the third filter coefficient, the processing system is configured to cause the UE to select at least one of:
the first filter coefficient from the first set of filter coefficients;
the second filter coefficient from the second set of filter coefficients; or
the third filter coefficient from the third set of filter coefficients.

10. The apparatus of claim 5, wherein:
each measurement value of the plurality of measurement values is associated with a respective output of the cooperative measurement output; and
to cause the UE to report the plurality of measurement values, the processing system is configured to cause the UE to report the plurality of measurement values and an indication of the respective output associated with each of the plurality of measurement values.

11. The apparatus of claim 3, wherein:
the processing system is configured to cause the UE to obtain signaling that configures the UE to:
determine a single measurement value based on the cooperative measurement output; and
report the single measurement value as the at least one measurement value; and
to cause the UE to report the at least one measurement value, the processing system is configured to cause the UE to, based on the signaling, report the single measurement value.

12. The apparatus of claim 11, wherein the processing system is configured to cause the UE to, at least based on the signaling, determine the single measurement value based on each output of the cooperative measurement output and a respective weight associated with each output.

13. The apparatus of claim 12, wherein the processing system is configured to cause the UE to:
before the UE determines the single measurement value, apply a filter to each output of one or more outputs of the cooperative measurement output to smooth each output based on one or more filter coefficients.

14. The apparatus of claim 11, wherein the processing system is configured to cause the UE to, at least based on the signaling, determine the single measurement value based on each output of the cooperative measurement output and a respective contribution percentage associated with each output.

15. The apparatus of claim 14, wherein the processing system is configured to cause the UE to:
before the UE determines the single measurement value, apply a filter to each output of one or more outputs of the cooperative measurement output to smooth each output based on one or more filter coefficients.

16. The apparatus of claim 3, wherein:
to cause the UE to report the at least one measurement value, the processing system is configured to cause the UE to report the at least one measurement value in accordance with one or more event conditions; and
the one or more event conditions comprise one or more of:
a first event condition where a first difference between a first event condition output of the cooperative measurement output and a second event condition output of the cooperative measurement output satisfies a first threshold;
a second event condition where a second difference between an average of the first event condition output and the second event condition output satisfies a second threshold;
a third event condition where a third difference between the average of the first event condition output and an average of the second event condition output satisfies a third threshold; or
a fourth event condition where at least one output of the cooperative measurement output satisfies a fourth threshold.

17. The apparatus of claim 16, wherein to cause the UE to report the at least one measurement value, the processing system is configured to cause the UE to:
based on the one or more event conditions, report at least one of:
the first difference;
the second difference;
the third difference;
the average of the first event condition output;
the average of the second event condition output; or
the at least one output of the cooperative measurement output.

18. The apparatus of claim 16, wherein the processing system is configured to cause the UE to:
obtain an indication of a plurality of available measurement determination methods, wherein the available measurement determination methods comprise:
the actual or predicted cooperative measurement; or
the actual or predicted cooperative measurement and the one or more third measurements by the UE; and
select a first measurement determination method and a second measurement determination method from the plurality of available measurement determination methods, wherein the first event condition output is based on the selected first measurement determination method and the second event condition is based on the selected second measurement determination method.

19. A method of wireless communications by a user equipment (UE), comprising:
identifying a group of UEs to which the UE belongs, the group of UEs associated with a co-location condition;
obtaining a cooperative measurement output based on, at least, an actual or predicted cooperative measurement by a subset of the group of UEs; and
reporting at least one measurement value, wherein the at least one measurement value is based on the cooperative measurement output.

20. One or more non-transitory computer-readable media comprising executable instructions that, when executed by one or more processors of an apparatus, cause a user equipment (UE) to perform operations comprising:
identifying a group of UEs to which the UE belongs, the group of UEs associated with a co-location condition;
obtaining a cooperative measurement output based on, at least, an actual or predicted cooperative measurement by a subset of the group of UEs; and
reporting at least one measurement value, wherein the at least one measurement value is based on the cooperative measurement output.
